(19) United States
(12) Patent Application Publication
(10) Pub. No.: US 2025/0225468 A1
(43) Pub. Date: Jul. 10, 2025

(54) SYSTEMS AND METHODS FOR ASSESSING AND PREDICTING CORPORATE PERFORMANCE BASED ON SOCIAL MEDIA CONTENT

(71) Applicant: Telemetry, LLC, Los Angeles, CA (US)

(72) Inventors: David Freeman Ford, Los Angeles, CA (US); Laura Baldwin Flowerree, Tiburon, CA (US); Jonathan Chung-Yin Wu, San Jose, CA (US); Lauren Ashlee Schwarz, San Diego, CA (US)

(21) Appl. No.: 19/013,539

(22) Filed: Jan. 8, 2025

Related U.S. Application Data
(60) Provisional application No. 63/619,130, filed on Jan. 9, 2024.

(51) Int. Cl. G06Q 10/0639; G06Q 10/1053; G06Q 50/00; H04L 67/306

(52) U.S. Cl. CPC G06Q 10/06393; G06Q 10/1053; G06Q 50/01; H04L 67/306

(57) ABSTRACT

Systems and methods for assessing and predicting corporate performance based on social media content are disclosed. For each individual, processor(s) are configured to chronologically sort a respective employment history. For each period-of-time within a period-of-interest, the processor(s) are configured to generate a respective company index score for each company based on a percentile rank of a respective metric value for a metric-of-interest relative to a respective set of benchmark companies; identify which individual(s) are associated with the reference company based on respective employment histories; for each individual associated with the reference company, calculate a respective individual index score based on the respective company index scores of the reference company and preceding company index scores of preceding companies-of-employment; and for the reference company, calculate a collective index score based on the individual index scores of the individuals associated with the reference company.

### CROSS-REFERENCE TO RELATED APPLICATION

This application claims the benefit of U.S. Provisional Patent Application No. 63/619,130, filed on Jan. 9, 2024, which is incorporated herein by reference in its entirety.

### TECHNICAL FIELD

The present disclosure generally relates to performance assessments and, more specifically, to systems and methods for assessing and predicting corporate performance based on social media content.

### BACKGROUND

The economy is competitive. Companies compete for customers and market share. They compete for investors. As a result, many companies and/or investors look to compare one company to another within a particular industry. For example, one company may compare itself to another to assess in which direction to move itself. An investor may compare one company to another to decide in which company to invest. However, it is oftentimes difficult to develop meaningful metrics with which to compare companies. Additionally, such comparisons are oftentimes backwards looking, and past performance oftentimes is not indicative of future performance.

Analytics have become increasingly prevalent when assessing company performance. Analytics is a technical field in which advanced computational analysis is performed on data to identify and communicate meaningful information and/or patterns within the data. Companies have used analytics to develop a better understanding of the performance of company portfolios, how companies are managed, how employees work, demographics for marketing campaigns, risk assessment, market strategies, etc.

Even with analytics, it is increasingly difficult to accurately predict how a company will perform in the future. Industries are everchanging, as are the direction of companies and their employees. For instance, executive and other employees change jobs frequently, making it difficult to assess the makeup and performance of a company. Additionally, there is oftentimes significant lag between the current output of employees and the future financial performance of a company due to, for example, the time it takes to develop, fine tune, and market a product and/or service. In turn, past and/or current financial performances of a company may not be indicative of future performance of the same company if changes within the company have relatively recently occurred within the company.

### SUMMARY

Example embodiments are disclosed for systems and methods for assessing and predicting corporate performance based on social media content. The present document discloses aspects of the embodiments and should not be used to limit corresponding claims. Other implementations are contemplated in accordance with the techniques described herein, as will be apparent to one having ordinary skill in the art upon examination of the following drawings and detailed description, and these implementations are intended to be within the scope of this application.

An example system for assessing and predicting corporate performance based on social media content includes one or more databases configured to store social media data of user profiles of users on a social media platform. The users include individuals and companies. The system includes one or more processors. For each of the individuals, the one or more processors are configured to chronologically sort a respective employment history. The one or more processors are configured to generate, for periods-of-time, metric values for metrics of the users based on the social media data; identify a reference company; and identify a metric-of-interest and a period-of-interest for assessment of the reference company. The period-of-interest includes one or more of the periods-of-time. For each of the periods-of-time within the period-of-interest, the one or more processors are configured to generate a respective company index score for each of the companies based on a percentile rank of the respective metric value for the metric-of-interest relative to a respective set of benchmark companies; identify which of the individuals are associated with the reference company based on the respective employment histories; for each of the individuals associated with the reference company, calculate a respective individual index score based on the respective company index scores of the reference company and preceding company index scores of preceding companies-of-employment; and for the reference company, calculate a collective index score based on the individual index scores of the individuals associated with the reference company. The one or more processors are configured to generate and transmit a report indicative of corporate performance of the reference company.

An example method for assessing and predicting corporate performance based on social media content includes storing, in one or more databases, social media data of user profiles of users on a social media platform. The users include individuals and companies. The method includes chronologically sorting, via one or more processors, a respective employment history for each of the individuals; generating, for periods-of-time via the one or more processors, metric values for metrics of the users based on the social media data; identifying a reference company; and identifying a metric-of-interest and a period-of-interest for assessment of the reference company. The period-of-interest includes one or more of the periods-of-time. For each of the periods-of-time within the period-of-interest, the method includes generating, via the one or more processors, a respective company index score for each of the companies based on a percentile rank of the respective metric value for the metric-of-interest relative to a respective set of benchmark companies; identifying, via the one or more processors, which of the individuals are associated with the reference company based on the respective employment histories; calculating, via the one or more processors, a respective individual index score for each of the individuals associated with the reference company based on the respective company index scores of the reference company and preceding company index scores of preceding companies-of-employment; and calculating, via the one or more processors, a collective index score for the reference company based on the individual index scores of the individuals associated with the reference company. The method includes generating and transmitting, via the one or more processors, a report indicative of corporate performance of the reference company.

An example computer readable medium comprising instructions, which, when executed, cause a machine to store, in one or more databases, social media data of user profiles of users on a social media platform. The users include individuals and companies. The instructions, when executed, cause the machine to chronologically sort a respective employment history for each of the individuals; generate, for periods-of-time, metric values for metrics of the users based on the social media data; identify a reference company; and identify a metric-of-interest and a period-of-interest for assessment of the reference company. The period-of-interest includes one or more of the periods-of-time. For each of the periods-of-time within the period-of-interest, the instructions, when executed, cause the machine to generate a respective company index score for each of the companies based on a percentile rank of the respective metric value for the metric-of-interest relative to a respective set of benchmark companies; identify which of the individuals are associated with the reference company based on the respective employment histories; calculate a respective individual index score for each of the individuals associated with the reference company based on the respective company index scores of the reference company and preceding company index scores of preceding companies-of-employment; and calculate a collective index score for the reference company based on the individual index scores of the individuals associated with the reference company. The instructions, when executed, cause the machine to generate and transmit a report indicative of corporate performance of the reference company.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which performance of companies is assessed and/or predicted based on social media content.

FIG. 2 is a block diagram of an example system for assessing and/or predicting the performance of companies based on social media content in accordance with the teachings herein.

FIG. 3 is an example flowchart for assessing and/or predicting the performance of companies based on social media content in accordance with the teachings herein.

FIG. 4 is an example sub-flowchart of the flowchart of FIG. 3 for collecting social media data and generating classification data.

FIG. 5 is an example sub-flowchart of the flowchart of FIG. 3 for chronologically sorting the employment history of individuals at companies based on the collected social media data.

FIG. 6 is example sub-flowchart of the flowchart of FIG. 3 for generating metric data for individuals and companies based on the collected social media data.

FIG. 7 is an example sub-flowchart of the flowchart of FIG. 3 for determining current and historical headcounts of companies.

FIG. 8 is an example sub-flowchart of the flowchart of FIG. 3 for identifying a set of benchmark companies for a reference company based on the generated classification and metric data.

FIG. 9 is an example sub-flowchart of the flowchart of FIG. 3 for determining a company index score for a reference company based on a comparison to benchmark companies.

FIG. 10 is an example sub-flowchart of the flowchart of FIG. 3 for determining individual index scores for individuals at a reference company and determining a collective index score for the reference company.

FIGS. 11-12 depict example social media content of an individual.

FIG. 13 depicts example social media content of a company.

FIG. 14 is a chart depicting a company index score over time.

FIG. 15 is a chart depicting an individual index score over time.

### DETAILED DESCRIPTION

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Example systems and methods disclosed herein automatically generate index scores of companies and/or individuals, based on social media content of companies and individuals collected from a social media platform, to assess the performance of those companies and/or individuals in a manner that is highly predictive of future performance of those companies.

As used herein, a “social media platform” refers to an interactive website and/or an app in which users may share content and/or connect with each other. Example social media platforms include YouTube®, TikTok®, and LinkedIn®. Users may include individuals and/or companies. As used herein, “social media content” refers to information and/or other content shared by user(s) on a social media platform. Example social media content includes text-based content, visual-based content, audio-based content, etc.

As used herein, a “social networking platform” refers to a type of a social media platform in which users may generate a profile and/or connect with each other. The connections or network of one user may be viewable by other users. Example social networking platforms include Facebook®, Twitter®, and LinkedIn®. Users of a social networking platform may include individuals and/or companies. For instance, users of LinkedIn® include individuals (e.g., employees) and companies (e.g., employers), with profiles of individuals including employment history (e.g., employer names, job titles, employment periods, etc.), qualifications, contact information, etc. and profiles of companies including company descriptions, specialties, contact information, etc.

Social media platforms are now widely used across the globe by both individuals and companies alike. For instance, LinkedIn®, a business- and employment-focused social networking platform, has more than 900,000,000 users across more than 200 countries. These users include both individuals (e.g., employees) and companies (e.g., employers), with each user having a profile that details their connections to other individuals and companies. That is, a business-focused social media platform, such as LinkedIn®, may be a single source of detailed information for a large number of companies across the globe. However, because of the large amount of data that is present for hundreds of millions of users, the data on social networking platforms can be unwieldly, even for some of the most powerful analytic tools.

Examples systems and methods disclosed herein are capable of analyzing the large amounts of content available on a social media platform, such as LinkedIn®, to automatically generate index scores for companies. The index scores facilitate the assessment of past performance and/or the prediction of future performance of companies and/or individuals relative to similar companies within the same industry (e.g., benchmark companies). Built-in constraints (or lack thereof) of one industry may cause companies operating within it to behave and/or perform differently than companies operating in another industry. For example, fast moving industries, such as software-based industries, may have faster growth and/or higher turnover than slower moving industries, such as commodities-based industries. By generating index scores based on similar companies within a shared industry, the example systems and methods disclosed herein are able to assess and predict the performance of companies in a meaningful manner.

To assess and predict company performance in such a manner, the examples disclosed herein collect social media content, chronologically sort employment histories of individuals included in the social media content, automatically generate new metric and classification data based on the collected social media content, automatically estimate historical headcounts for companies based on the collected social media content, automatically identify benchmark companies for a reference company based on the generated metric and/or classification data and the estimated historical headcounts, and/or automatically generate index score(s) for the reference company. Thus, the examples disclosed herein include an unconventional and specific set of rules to generate new data based on social media content and then analyze the generated data to accurately benchmark companies and individuals in an automated manner, which has not been and likely would not otherwise be implemented by those in search of assessing and predicting company performance with corporate analytic tools.

As used herein, a “company index score” refers to a score of a company indicating how well the company performed, compared to benchmark companies, for a metric-of-interest during a period-of-time. A company index score reflects the past performance of a company, which may facilitate improved predictions of future performance of the company (e.g., especially if it has consistently overperformed or underperformed). Example company index scores may be in the form of percentile ranks or scores.

As used herein, an “individual index score” refers to a score of an individual indicating how well companies performed, compared to their benchmark companies, while the individual worked for those companies. An individual index score reflects the past performance of an individual, which may facilitate improved predictions of future performance of a company at which the individual currently works (e.g., especially for executive-level individuals that have consistently overperformed or underperformed). Example individual index scores may be in the form of percentile ranks or scores.

As used herein, a “collective index score” refers to a score of a company indicating how well it and other companies performed, compared to their benchmark companies, while its current workers worked for those companies. A collective index score reflects the current performance of the company, based on the past performance of its current workers, which may be highly predictive of the future performance of the company (e.g., especially if its current workers have consistently overperformed or underperformed). Example collective index scores may be in the form of percentile ranks or scores.

As used herein, a “reference company” refers to a company whose performance is to be assessed relative to benchmark companies. A reference company may refer to an entire company, a department within a company, a seniority position within a company, a region in which a portion of a company is located, a seniority position in a department of a company, etc.

As used herein, a “peer company” refers to a company that is identified as being similar to a reference company. For example, a company may be selected as a peer company for being in the same industry as a reference company and for having a similar headcount as that of the reference company. A peer company may refer to an entire company, a department within a company, a seniority position within a company, a region in which a portion of a company is located, a seniority position in a department of a company, etc. Benchmark companies may be selected from a pool of peer companies.

As used herein, a “benchmark company” refers to a company that is identified for comparison to a reference company. A benchmark company may refer to an entire company, a department within a company, a seniority position within a company, a region in which a portion of a company is located, a seniority position in a department of a company, etc.

As used herein, a “headcount” refers to the number of people employed by and/or otherwise working for a company.

As used herein, a “period-of-time” and a “POT” refer to a predefined measurement-of-time by which metrics for companies and/or individuals are assessed. Each period-of-time has the same duration (e.g., 1 week, 1 month, 3 months, 1 year, etc.) as the others. Each period-of-time may be represented by a respective field within a database (e.g., a social media database, a date database, a metric database, a benchmark database, an index score database, etc.), and the fields may be arranged such that the periods-of-time are arranged chronologically within the database.

As used herein, a “predefined-time-interval” refers to a predefined time duration across which a change in metric values of a first metric (e.g., a headcount metric) is measured to determine a metric value of a second metric (e.g., a change-in-headcount metric). A predefined-time-interval extends along one or more contiguous periods-of-time between a start period-of-time (POT) and an end period-of-time (POT). Example predefined-time-intervals may extend 3 months, 6 months, 12 months, 24 months, 36 months, etc.

As used herein, a “period-of-interest” refers to a time period during which a reference company and/or individuals of a reference company are compared to benchmark companies and/or individuals of benchmark companies. For example, a reference company may be compared to its benchmark companies for a period-of-interest based on their respective company index scores and/or collective index scores. Individual(s) of a reference company may be compared to individuals of benchmark companies for a period-of-interest based on their respective individual index scores.

As used herein, “social media data” refers to information collected from social media platform(s), such as social networking platform(s), that indicate how users of those social media platform(s) view, comment on, share, and/or otherwise engage with content and/or profiles of other users. Example social media data includes profile information, connections, etc. of a user, such as an individual or a company. Social media data may be obtained from an operating company of a social media platform, the social media platform via scraping, obtained from third-party vendor(s), etc.

As used herein, “classification data” refers to data that is indicative of one or more classifications and/or sub-classifications of companies and/or individuals. Example classification data includes classifications and/or sub-classifications of industries, departments, seniority, and/or locations of companies and/or individuals. Classification data may be generated from social media data associated with companies and individuals.

As used herein, “metric data” refers to data that is indicative of how companies and/or individuals compare to each other in light of one or more metrics. Metric data may be generated from social media data associated with companies and individuals. Example metric data includes a metric values of one or more metrics-of-interest for each company and/individual identified in social media data.

As used herein, a “metric-of-interest” refers to a metric by which a reference company is compared to benchmark companies and/or an individual of a reference company is compared to individuals of benchmark companies. Example types of metrics-of-interest include headcount metrics, time-interval metrics, diversity metrics, gender-equity metrics, individual-tenure metrics, company-tenure metrics, etc.

As used herein, a “longitudinal date profile” refers to a representation of a date range in database form in which each record (e.g., row) in a database corresponds with a respective date range and each field (e.g., column) in the database corresponds with a respective period-of-time. A longitudinal date profile may include a field value for each field corresponding with a period-of-time corresponding with the date range.

As used herein, a “headcount signal score” refers to a ratio between (1) the self-reported current headcount of a company and (2) the number of individuals that self-identify as currently working at the company. For example, a company may self-report its current headcount on its profile on a social-media platform, and an individual may self-identify the company for which they currently work on their profile on a social-media platform. The headcount signal score may be used to calculate historical headcounts of a company in instances in which self-reported historical data of the company is incomplete.

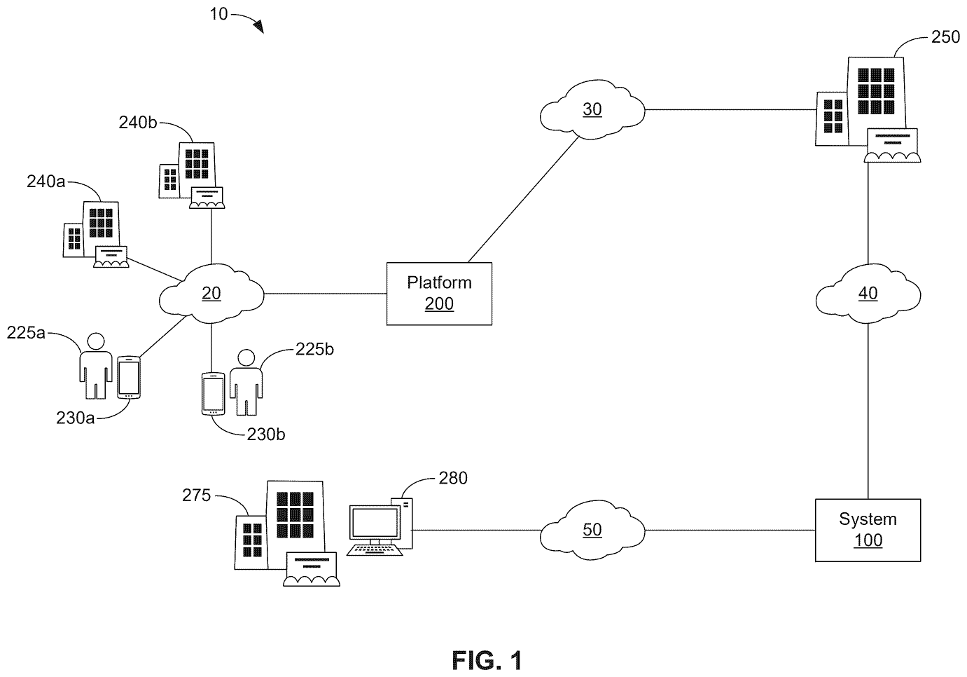

Turning to the figures, FIG. 1 illustrates an example environment in which performance of companies is assessed and/or predicted based on social media content in accordance with the teachings herein.

The environment 10 includes a social media platform 200. In the illustrated example, the social media platform 200 is a business- and employment-focused social networking platform, such as LinkedIn®. The environment includes a plurality of social media users of the social media platform 200.

For example, one or more individuals 225 use and interact with the social media platform 200 via a network 20. The network 20 may be a public network, such as the Internet, or a private network, such as an intranet. Each of the individuals 225 interacts with the social media platform 200 via a respective computing device 230. In the illustrated example, each computing device 230 is a smartphone. In other examples, one or more of the computing devices 230 may be a desktop, a laptop, a tablet, a smartwatch, and/or any other computing device capable of accessing a social media platform.

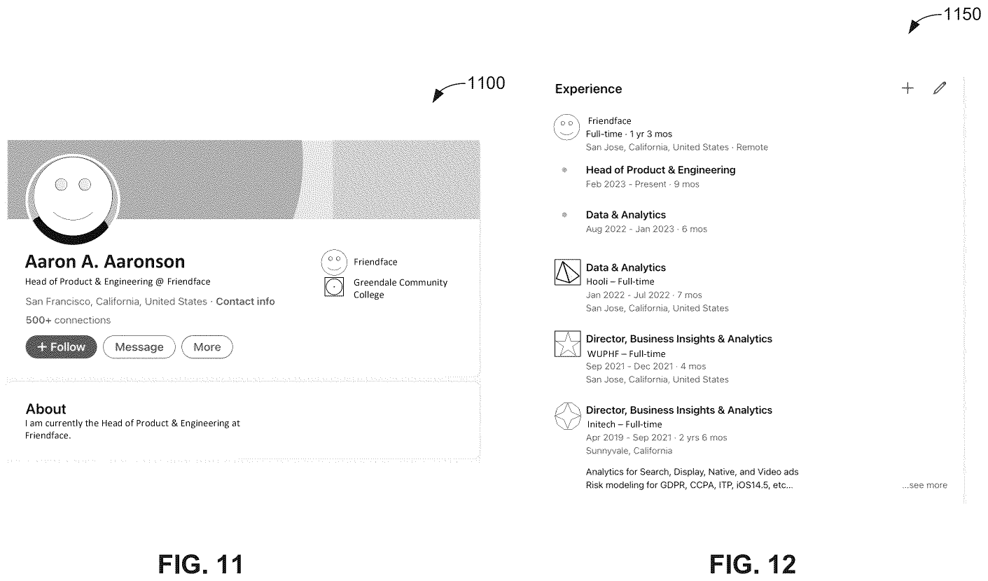

Each of the individuals 225 has a corresponding profile on the social media platform 200. FIGS. 11-12 depict portions of an example profile for one of the individuals 225 on the social media platform 200. As shown in FIG. 11, a portion 1100 of the profile of an individual 225 includes a brief summary of the career of the individual 225. As shown in FIG. 12, a portion 1150 of the profile of the individual 225 includes an employment history of the individual 225. For each position held by the individual 225, the employment history may include an employer or company name, a job title, a job description, and/or an employment period (e.g., a date range) during which the individual 225 held the respective position.

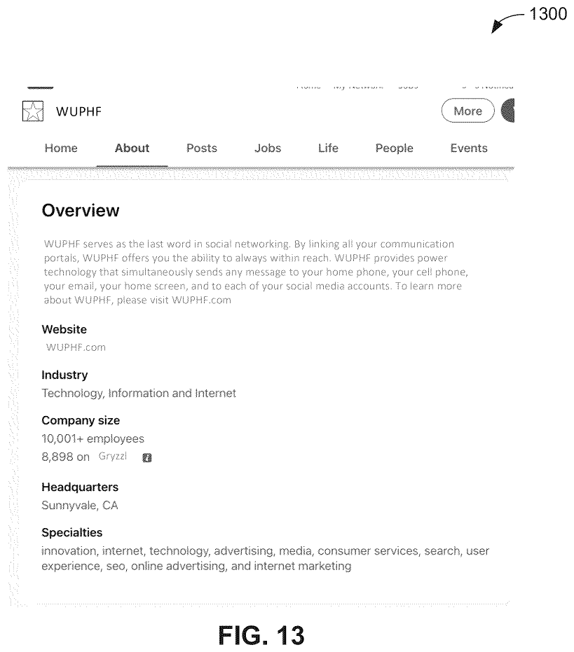

Returning to FIG. 1, one or more companies 240 use and interact with the social media platform 200 via the network 20. Each of the companies 240 has a corresponding profile on the social media platform 200. FIG. 13 depicts a portion 1300 of an example profile for one of the companies 240 on the social media platform 200. In the illustrated example, the profile for one of the companies 240 includes a description or overview of the company 240, contact information (e.g., a website), a brief description of the industry in which the company 240 operates, a headcount provided by the company 240, a location (e.g., a headquarters location) of the company 240, and specialties of the company 240 within the its industries.

Returning again to FIG. 1, the environment 10 also includes a third-party vendor 250. In the illustrated example, the third-party vendor 250 collects social media data from the social media platform 200 via a network 30 and aggregates the collected social media data for subsequent analysis by other parties. The third-party vendor 250 may scrape and/or otherwise obtain publicly available social media data from the social media platform 200. The network 30 may be a public network, such as the Internet, or a private network, such as an intranet.

For each individual 225, the social media data collected by the third-party vendor 250 may include a name and/or employment history included in the profile of the individual 225 on the social media platform 200. For each company 240, the social media data collected by the third-party vendor 250 may include a description, a size (e.g., employee count), a location (e.g., of its headquarters), industries of operation, and/or any specialties of the company 240 as included in the profile of the company 240 on the social media platform 200. The collected social media data may be aggregated in a database for other parties or systems, such as a benchmarking system 100 of the environment 10 of FIG. 1.

The example benchmarking system 100 disclosed herein is configured to obtain the social media data of the social media platform 200. In the illustrated example, the benchmarking system 100 collects the social media data from the third-party vendor 250 via a network 40. The network 40 may be a public network, such as the Internet, or a private network, such as an intranet. In other examples, the benchmarking system 100 is configured to collect publicly available social media data directly from the social media platform 200 (e.g., via scraping) and subsequently aggregate the collected data.

The environment 10 also includes a reference company 275. In the illustrated example, the reference company 275 is communicatively connected via a network 50. The network 50 may be a public network, such as the Internet, or a private network, such as an intranet. In the illustrated example, each of the networks 20, 30, 40, 50 are separate from each other. In other examples, the network 20, the network 30, the network 40, and/or the network 50 are combined as a single network (e.g., the Internet).

As further detailed below, the benchmarking system 100 is configured to identify benchmark companies of the reference company 275 and compare the reference company to those benchmark companies to generate index scores that facilitate the assessment of past performance and/or the prediction of future performance of the reference company 275 within its industry. For example, the benchmarking system 100 is configured to generate a company index score of a company and/or an individual index score of an individual that assess the past performance of the company and/or individual, respectively, to facilitate the prediction of the future performance of that company and/or individual. Additionally or alternatively, the benchmarking system 100 is configured to generate a collective index score of a company that assesses the past performance of the current employees of the company to predict the current and/or future performance of the company.

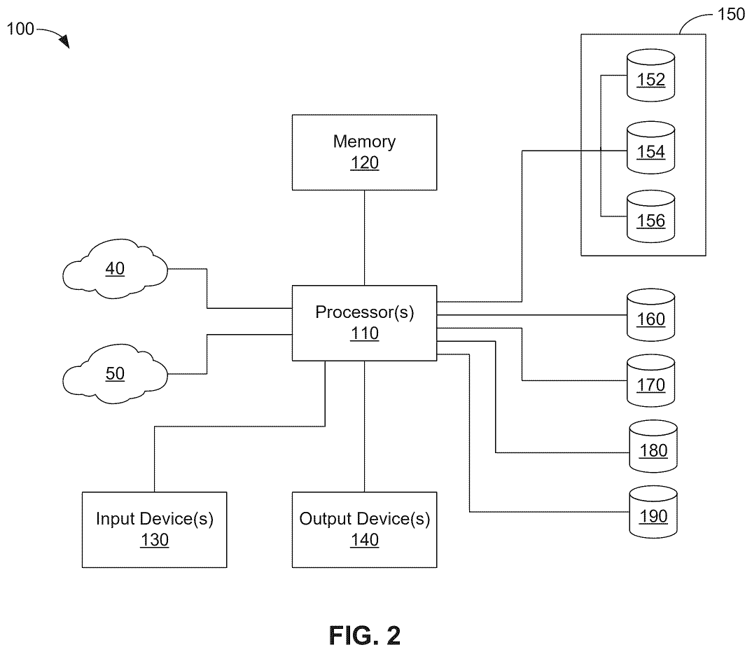

FIG. 2 depicts a block diagram of the benchmarking system 100. In the illustrated example, the benchmarking system 100 includes one or more processors 110, memory 120, one or more input devices 130, and one or more output device 140. The benchmarking system 100 also includes one or more social media databases 150, a date database 160, a metric database 170, a benchmark database 180, and an index score database 190.

The processor(s) 110 may be any suitable processing device or set of processing devices such as, but not limited to, a microprocessor, a microcontroller-based platform, an integrated circuit, etc. The processor(s) 110 are communicatively connected to the network 40 to collect information, such as social media data, from the social media platform 200 and/or the third-party vendor 250. The processor(s) 110 are communicatively coupled to the network 50 to collect information, such as social media data, from the reference company 275 and to transmit information, such as benchmarking reports, to the reference company 275.

The memory 120 may include one or more of volatile memory, non-volatile memory, read-only memory, etc. In some examples, the memory 120 may include a combination of multiple kinds of memory, such as volatile memory and non-volatile memory. The memory 120 is computer readable media on which one or more sets of instructions, such as the software for operating the methods of the instant disclosure, can be embedded. The instructions may embody one or more of the methods or logic as described herein. For example, the instructions reside completely, or at least partially, within any one or more of the memory 120, the computer readable medium, and/or within the processor(s) 110 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The input device(s) 130 enable an operator, such as an information technician or analyst of the benchmarking system 100, to provide instructions, commands, and/or data to the processor(s) 110. Additionally or alternatively, the input device(s) 130 enable the operator to modify and/or update the instructions stored in the memory 120 and/or data stored in the social media database(s) 150, the date database 160, the metric database 170, the benchmark database 180, and/or the index score database 190. Example input device(s) 130 include a keyboard, a mouse, a touch screen, a touchpad, a speech recognition system, an instrument panel, button(s), control knob(s), etc.

The output device(s) 140 display output information and/or data of the benchmarking system 100 to an operator, such as an information technician or analyst. Example output device(s) 140 include a liquid crystal display (LCD), an organic light emitting diode (OLED) display, a flat panel display, a solid-state display, and/or any other device that visually presents information to a user. Additionally or alternatively, the output device(s) 140 may include one or more speakers and/or any other device(s) that provide audio output signals for the operator. Further, the output device(s) 140 may provide other types of output information, such as haptic signals.

In the illustrated example, the social media database(s) 150, the date database 160, the metric database 170, the benchmark database 180, and the index score database 190 are separate from each other. In other examples, the social media database(s) 150, the date database 160, the metric database 170, the benchmark database 180, and/or the index score database 190 may be combined in the form of a single database. Additionally or alternatively, one or more of the social media database(s) 150, the date database 160, the metric database 170, the benchmark database 180, and/or the index score database 190 may collectively be formed by a plurality of different databases. For example, the social media database(s) 150 include and are formed by a combination of a company database 152, an individual database 154, and an employment database 156. The data stored in the company database 152, the individual database 154, and the employment database 156 may aggregated together as social media data that is subsequently processed and analyzed to assess and predict the performance of one or more companies.

In operation, the social media database(s) 150 are configured to store social media data of companies and individuals on the social media platform 200 that are collected from the third-party vendor 250 and/or directly from the social media platform 200.

For example, the company database 152 of the social media database(s) 150 is configured to store data corresponding to companies on the social media platform 200. Each row or record of the company database 152 corresponds to a respective company and includes data associated with the respective company. In some examples, the stored data for each company includes data entries for the following data types: a company name, a self-reported headcount, an employee profile count, a self-reported industry classification, a headquarters location, a headquarters country, and/or a numeric identification (ID).

In some examples, the processor(s) 110 clean and/or annotate the company data collected from the social media platform 200. For example, the processor(s) 110 are configured to remove stop words and/or punctuation from data entries. The processor(s) 110 are configured to translate any text collected in a foreign language to a preselected language (e.g., English). Additionally or alternatively, the processor(s) 110 are configured to determine and annotate the field with “valid” or “invalid” based on information included in the field.

Further, in some examples, the processor(s) 110 classify and/or supplement the company data collected from the social media platform 200. For example, the processor(s) 110 are configured to convert a headquarters location expressed in text as a city, metro region, a region, and/or a country (e.g., “San Fransisco, California,” “Greater Milwaukee Area, United States”) to a latitudinal and longitudinal coordinate. The processor(s) 110 are configured to then assign and store one or more level(s) of geographic granularity (e.g., region, subregion, country, state, city, designated marketing area (DMA), metro area, etc.) to the corresponding company. Example regions include North America; Europe, the Middle East and Africa (EMEA); and Asia/Pacific. Example subregions include Western Europe, Eurasia, etc. If the assigned country does not match the country self-reported by the company in the company data, the processor(s) 110 are configured to select which of the two countries to select for designation for the corresponding company.

The processor(s) 110 also are configured to assign an industry category (also referred to as “Industry 1”) and an industry subcategory (also referred to as “Industry 2”) to the company based on the self-reported industry classification of the company in the company data collected from the social media platform 200. In other examples, the processor(s) 110 are configured to assign an industry category and an industry subcategory to a corresponding company using an internal classification model based on a plurality of data sources (e.g., the self-reported industry classification of the company, a workforce composition of the company, text from a website of the company, external sources for company classifications, etc.).

The individual database 154 of the social media database(s) 150 is configured to store data corresponding to individuals on the social media platform 200. Each row or record of the individual database 154 corresponds to a respective individual and includes data associated with the respective individual. In some examples, the stored data for each individual includes data entries for the following data types: a first name, a last name, a profile title, a location of residence, a country of residence, and/or a numeric identification (ID).

In some examples, the processor(s) 110 clean and/or annotate the individual data collected from the social media platform 200. For example, the processor(s) 110 are configured to remove stop words and/or punctuation from data entries. The processor(s) 110 are configured to translate any text collected in a foreign language to a preselected language (e.g., English). Additionally or alternatively, the processor(s) 110 are configured to determine and annotate the field with “valid” or “invalid” based on information included in the field.

Further, in some examples, the processor(s) 110 classify and/or supplement the individual data collected from the social media platform 200. For example, the processor(s) 110 are configured to convert a residence location expressed in text as a city, metro region, a region, and/or a country (e.g., “San Fransisco, California,” “Greater Milwaukee Area, United States”) to a latitudinal and longitudinal coordinate. The processor(s) 110 are configured to then assign and store one or more level(s) of geographic granularity (e.g., region, subregion, country, state, city, designated marketing area (DMA), metro area, etc.) to the corresponding individual. If the assigned country does not match the country self-reported by the individual in the company data, the processor(s) 110 are configured to select which of the two countries to select for designation for the corresponding individual. Additionally or alternatively, the processor(s) 110 are configured to assign a gender probability to a corresponding individual based on the first name included in the individual data collected from the social media platform 200. For example, the processor(s) 110 are configured to identify that an individual having a first name of “Charlie” has a female probability of 16% and male probability of 84%.

The employment database 156 of the social media database(s) 150 is configured to store data corresponding to a position held by an individual on the social media platform 200. Each row or record of the employment database 156 corresponds to a respective position of the employment history of one of the individuals on the social media platform 200 and includes data associated with the respective employment position. Each individual may correspond with one or more rows or data fields, with each row or record corresponding with a different position of the employment history of that individual. In some examples, the stored data for each employment includes data entries for the following data types: a job title, a job description, a company name, a date range, a numeric identification (ID) of the employment position, and a numeric identification (ID) of the individual associated with the employment position.

In some examples, the processor(s) 110 clean and/or annotate the employment data collected from the social media platform 200. For example, the processor(s) 110 are configured to remove stop words and/or punctuation from data entries. The processor(s) 110 are configured to translate any text collected in a foreign language to a preselected language (e.g., English). Additionally or alternatively, the processor(s) 110 are configured to determine and annotate the field with “valid” or “invalid” based on information included in the field. The processor(s) 110 also are configured to convert a date entry from text form (e.g., February 2005) to date form (e.g., 2005 Feb. 1).

Further, in some examples, the processor(s) 110 classify and/or supplement the employment data collected from the social media platform 200. For example, the processor(s) 110 are configured to classify a job title of a position in the employment history of an individual. The processor(s) 110 are configured to classify a job title by department (e.g., sales, product development, finance, etc.), seniority (e.g., an individual contributor, a student/intern, a manager, a leadership position, an executive, an advisor or board member, etc.), and/or work type (e.g., job, temporary, unemployed, volunteer, student, retired, advisor, etc.). In some examples, the processor(s) 110 are configured determine the department, seniority, and/or work type of a job title based on analysis of the job title included in the employment data. In other examples, the processor(s) 110 may consider other information to identify a more refined classification of the job title (e.g., “Regional Manager of Sales” as opposed to “Manager”). For, example, the processor(s) 110 are configured determine the department, seniority, and/or work type of the job title based on analysis of the job title, a description associated with the job title in a corresponding employment history of an individual, other descriptions associated with the corresponding employment history, skills and/or certificates associated with the corresponding individual, other employment experiences identified in the corresponding employment history, etc. Further, in some examples, the processor(s) 110 are configured to perform multi-class classification using a machine learning algorithm, such as a bidirectional encoder representations from transformers (BERT) based language model, to identify the department, seniority, and/or work type associated with the job title. The processor(s) 110 also are configured to further aggregate the assigned department into a category and subcategory.

The date database 160 is configured to store each date range during which an individual held a respective job title. In some examples, the date database 160 is configured to store the date ranges of job titles in the form of longitudinal date profiles. For example, each record (e.g., row) in the date database 160 corresponds with a respective position of the employment history of one of the individuals on the social media platform 200 and includes data identifying the corresponding individual, company, and/or job title. Further, each field (e.g., column) in the date database 160 corresponds with a respective period-of-time (e.g., a week, a month, a year, etc.). Each period-of-time has the same length as the others, and the periods-of-time are arranged chronologically. To convert a date range to a longitudinal date profile, the processor(s) 110 create a field value for each period-of-time during which the corresponding individual held the corresponding job title. In turn, the date database 160 includes a field value for each period-of-time of an individual's employment history. In some examples, the processor(s) 110 generate a respective field value for each period-of-time between the “start date” and the “end date+1 additional period-of-time” to facilitate subsequent analysis of attrition headcount metric(s).

The metric database 170 is configured to store classification data and/or metric data associated with companies and/or individuals identified in the social media data collected from the social media platform 200. The processor(s) 110 generate classification and metric data and store the classification and metric data in the metric database 170. The processor(s) 110 generate the classification and metric data for each company and individual based on the social media data stored in the social media database(s) 150 and the employment date data stored in the date database 160.

Example classification data generated by the processor(s) 110 includes department, seniority, and/or location classification data for individuals. Additionally or alternatively, classification data generated by the processor(s) 110 includes headquarter location and/or industry classification data for companies. Department classifications include a department group classification and a department sub-classification. Seniority classifications include a seniority group classification and a seniority sub-classification. Location classifications include a region classification, a sub-region sub-classification, and a country sub-classification. Industry classifications include an industry classification (e.g., “Industry 1”) and an industry sub-classification (e.g., “Industry 2”).

In some examples, metric data generated by the processor(s) 110 and stored in the metric database 170 includes headcount metric data for each company included in the social media data of the social media platform 200. The headcount metric data of a company is indicative of a headcount of a company at a particular period-of-time. That is, the headcount metric data may be indicative of how quickly a company is growing and/or how well the company retains its workforce.

The processor(s) 110 are configured to generate the headcount metric data based on data stored in the social media database(s) 150 and/or date database 160. The longitudinal date profiles of the date database 160 facilitate the processor(s) 110 in quickly and accurately calculating the headcount metric data for each of the companies by enabling the processor(s) 110 to identify which individuals correspond with a particular company at a particular period-of-time. In some examples, the date database 160 include data indicative of an individual having multiple employment positions at the same time. If each simultaneous role of the individual is at a different respective company, the processor(s) 110 are configured to consider that individual for each company for that period-of-time. If two or more simultaneous roles of the individual are at one company, the processor(s) 110, for example, are configured to prioritize the most recent position so that only the corresponding record for that individual is considered when determining the headcount for that company at that period-of-time.

Example headcount metric data includes a respective metric value for one or more of the following metrics for each company: a total-headcount metric, a new-headcount metric, a lost-headcount metric, and/or a retained-headcount metric. The headcount metric data is based on the self-reported headcount values included in the social media data that the corresponding companies have provided on the social media platform 200.

The total-headcount metric is indicative of a total number of individuals that are at a corresponding company at a corresponding period-of-time.

The new-headcount metric is indicative of a total number of individuals that were added by a corresponding company during a corresponding period-of-time (e.g., the number of individuals present in one period-of-time that were not present during the previous period-of-time).

The lost-headcount metric is indicative of a total number of individuals that were lost by a corresponding company during a corresponding period-of-time (e.g., the number of individuals not present for one period-of-time but were present for the previous period-of-time).

The retained-headcount metric is indicative of a total number of individuals that were retained during a corresponding period-of-time (e.g., the number of individuals present for one period-of-time that were also present for the previous period-of-time).

In some examples, headcount metric data includes time-interval metric data that is indicative of change in headcount of a company over a predefined-time-interval. That is, the time-interval metric data may be indicative of how quickly a company is growing over a predefined-time-interval. For example, the processor(s) 110 are configured to calculate time-interval metric data for headcount changes between a start period-of-time (POT) and an end period-of-time (POT) over a 3-month predefined-time-interval, a 6-month predefined-time-interval, a 12-month predefined-time-interval, a 24-month predefined-time-interval, a 36-month predefined-time-interval, etc. That is, the start POT is the first period-of-time of the predefined-time-interval, and end POT is the last period-of-time of the predefined-time-interval.

Example time-interval metric data is indicative of the quantity and/or efficiency at which individuals are hired and/or retained by a company. Such turnover metric data includes a respective metric value for one or more of the following turnover metrics for each company: a net-headcount-growth metric, an addition-rate metric, an attrition-rate metric, and/or a growth-efficiency metric.

The net-headcount-growth metric is indicative of a net change in headcount of a corresponding company over a corresponding predefined-time-interval (e.g., 3 months, 6 months, 12 months, 24 months, 36 months, etc.). The processor(s) 110 calculate a metric value for the net-headcount-growth metric using the following formula: net-headcount-growth=(total-headcount at end POT)/(total-headcount at start POT)−1.

The addition-rate metric is indicative of a rate at which individuals are added to a corresponding company over a corresponding predefined-time-interval. The processor(s) 110 calculate a metric value for the addition-rate metric using the following formula: (summation of new-headcounts for periods-of-time during predefined-time-interval)/(total-headcount at start POT).

The attrition-rate metric is indicative of a rate at which individuals are lost by a corresponding company over a corresponding predefined-time-interval. The processor(s) 110 calculate a metric value for the attrition-rate metric using the following formula: (summation of lost-headcounts for periods-of-time during predefined-time-interval)/(total-headcount at start POT).

The growth-efficiency metric is indicative of an efficiency rate at which a corresponding company adds and retains individuals over a corresponding predefined-time-interval. The processor(s) 110 calculate a metric value for the growth-efficiency metric using the following formula: (net-headcount-growth)/(addition-rate+attrition-rate).

Other example headcount metric data is indicative of diversity and/or gender equity at a company. Example gender-equity metric data is indicative of how well the company hires and retains women. For example, gender-equity metric data is calculated, at least in part, based on the female probabilities assigned by the processor(s) 110 to individuals associated with the company for a corresponding period-of-time. Example gender-equity metric data includes a respective metric value for one or more of the following gender-equity metrics for each company: a female-probability-average metric, a total-female-headcount metric, a new-female-headcount metric, a lost-female-headcount metric, and/or a retained-female-headcount metric.

A female-probability-average metric is indicative of a proportion of a headcount of a group-of-interest of a company for a period-of-time that is predicted to be female. The processor(s) 110 calculate a metric value for a female-probability-average by averaging the female probability for each individual within the group-of-interest during the period-of-time.

For example, the processor(s) 110 are configured to calculate a metric value for a total-headcount-female-probability-average by averaging the female probability for each individual within the company during the period-of-time. The processor(s) 110 are configured to calculate a metric value for a new-headcount-female-probability-average by averaging the female probability for each individual that has been hired by the company during the period-of-time. The processor(s) 110 are configured to calculate a metric value for a lost-headcount-female-probability-average by averaging the female probability for each individual that has left the company during the period-of-time. The processor(s) 110 are configured to calculate a metric value for a retained-headcount-female-probability-average by averaging the female probability for each individual that has remained at the company during the period-of-time.

The total-female-headcount metric is indicative of a total number of females that are at a company at a corresponding period-of-time. The processor(s) 110 are configured to calculate a metric value for the total-female-headcount metric for a period-of-time by multiplying the corresponding total-headcount-female-probability-average and the corresponding total-headcount.

The new-female-headcount metric is indicative of a total number of females that were added by a company at a corresponding period-of-time. The processor(s) 110 are configured to calculate a metric value for the new-female-headcount metric for a period-of-time by multiplying the corresponding new-headcount-female-probability-average and the corresponding new-headcount.

The lost-female-headcount metric is indicative of a total number of females that were lost by a company at a corresponding period-of-time. The processor(s) 110 are configured to calculate a metric value for the lost-female-headcount metric for a period-of-time by multiplying the corresponding lost-headcount-female-probability-average and the corresponding lost-headcount.

The retained-female-headcount metric is indicative of a total number of females that were retained by a company at a corresponding period-of-time. The processor(s) 110 are configured to calculate a metric value for the retained-female-headcount metric for a period-of-time by multiplying the corresponding retained-headcount-female-probability-average and the corresponding retained-headcount.

Additionally or alternatively, the processor(s) 110 may be configured to calculate male-based versions of the probability-average metrics, the total-headcount metric, the new-headcount metric, the lost-headcount metric, and/or the retained-headcount metric. Further, the processor(s) 110 are configured to calculate versions of the probability-average metrics, the total-headcount metric, the new-headcount metric, the lost-headcount metric, and/or the retained-headcount metric for other characteristics related to diversity.

In some examples, metric data generated by the processor(s) 110 and stored in the metric database 170 includes individual-tenure metric data for each individual included in the social media data of the social media platform 200. The individual-tenure metric data is indicative of a how long an individual remains with a corresponding company.

The processor(s) 110 are configured to generate the individual-tenure metric data based on data stored in the social media database(s) 150 and/or date database 160. The longitudinal date profiles of the date database 160 facilitate the processor(s) 110 in quickly and accurately calculating the individual-tenure metric data for each of the individuals by enabling the processor(s) 110 to quickly identify which companies correspond with a particular individual at a particular period-of-time. In some examples, the date database 160 include data indicative of an individual having multiple employment positions at the same time. The processor(s) 110 are configured to avoid double-counting any corresponding period-of-time associated with multiple employment.

Example individual-tenure metric data includes a respective metric value for one or more of the following metrics for each company: a career-tenure metric, a company-tenure metric, a role-tenure metric, an experience-tenure metric, and/or an industry-tenure metric.

The career-tenure metric is indicative of the total number of periods-of-time, as of a particular period-of-time, for which an individual has at least one employment position (e.g., a valid employment position) listed in their employment history.

The company-tenure metric is indicative of the total number of periods-of-time, as of a particular period-of-time, for which an individual has held at least one employment position (e.g., a valid employment position) at a corresponding company.

The role-tenure metric is indicative of the total number of periods-of-time, as of a particular period-of-time, for which an individual has held a corresponding employment position (e.g., a valid employment position).

The experience-tenure metric is indicative of the total number of contiguous periods-of-time, as of a particular period-of-time, for which an individual has held at least one employment position (e.g., a valid employment position) at a corresponding company.

The industry-tenure metric is indicative of the total number of periods-of-time, as of a particular period-of-time, for which an individual has held an employment position (e.g., a valid employment position) within an industry classification that corresponds with the company associated with the employment position.

In some examples, the metric data generated by the processor(s) 110 and stored in the metric database 170 includes company-tenure metric data for each company included in the social media data of the social media platform 200. The company-tenure metric data is indicative of the average tenure of individuals at a corresponding company. That is, the company-tenure metric data may be indicative of how well the company retains and/or develops its staff and/or a level of experience of its workforce. The processor(s) 110 are configured to generate the company-tenure metric data based on individual-tenure metric data, data stored in the social media database(s) 150, and/or data stored in date database 160. The longitudinal date profiles of the date database 160 facilitate the processor(s) 110 in quickly and accurately calculating the company-tenure metric data for each of the companies by enabling the processor(s) 110 to quickly identify which individuals correspond with a particular company at a particular period-of-time.

In some examples, the processor(s) 110 are configured to calculate company-tenure metrics for an entire company. Additionally or alternatively, the processor(s) 110 are configured to calculate company-tenure metrics for a particular group-of-interest within a company, such as a department, a seniority position, a region, a seniority position in a department, etc.

Example company-tenure metric data includes a respective metric value for one or more of the following metrics for each company: an average-career-tenure metric, an average-company-tenure metric, an average-role-tenure metric, an average-experience-tenure metric, and/or an average-industry-tenure metric.

The average-career-tenure metric is indicative of the average tenure of individuals of a particular company at a particular period-of-time that the individuals have accrued throughout their career. That is, the average-career-tenure metric is indicative of a level of experience and/or seniority of a workforce of a company. The average-career-tenure metric considers both the tenures that individuals have accrued while at the particular company and other tenures that the individuals previously accrued at other companies throughout their career.

The average-company-tenure metric is indicative of the average tenure of individuals of a particular company at a particular period-of-time that the individuals have accrued at that particular company. That is, the average-career-tenure metric is indicative of how well the company retains its workers. The average-company-tenure metric only considers the tenures that individuals have accrued while at the particular company.

The average-role-tenure metric is indicative of the average tenure of individuals in their respective positions at a particular company at a particular period-of-time. That is, the average-role-tenure metric is indicative of how well the company promotes and/or creates career paths for its workers.

The average-experience-tenure metric is indicative of the average contiguous tenure of individuals of a particular company at a particular period-of-time that the individuals have accrued contiguously at that particular company. That is, the average-experience-tenure metric is indicative of how well the company retains its workers.

The average-industry-tenure metric is indicative of the average tenure of individuals of a particular company at a particular period-of-time that the individuals have accrued for the industry classification that corresponds with the particular company. That is, the average-industry-tenure metric is indicative of a level of experience and/or seniority of a workforce of a company within the industry of the company.

In some examples, company-tenure metric data includes diversity and/or gender-equity data such as an average-female-career-tenure metric, an average-female-company-tenure metric, an average-female-role-tenure metric, an average-female-experience-tenure metric, and/or an average-female-industry-tenure metric. In some examples, the processor(s) 110 are configured to calculate the diversity and/or gender-equity data by considering only the tenures of individuals of who are likely to correspond with diversity and/or gender characteristic based on respective calculated probabilities of those individuals. For example, the processor(s) 110 are configured to calculate female-based company-tenure metric data by considering only the tenures of individuals of a particular company that are likely to be a female worker based on the respective female probabilities of those individuals.

The average-female-career-tenure metric is indicative of the average tenure of female workers at a particular company at a particular period-of-time that they have accrued throughout their career. That is, the average-female-career-tenure metric is indicative of a level of experience and/or seniority of a female workers of a company. The processor(s) 110 are configured to calculate a metric value for the average-female-career-tenure by (1) identifying a career tenure and a female probability for each individual associated with a company at the corresponding period-of-time, (2) calculating a female tenure for each individual by multiplying the respective career tenure and the respective female probability, (3) calculating an average female tenure among the individuals at the company for the corresponding period-of-time, (4) calculating an average female probability among the individuals at the company for the corresponding period-of-time, and (5) weighting the average female tenure by dividing the average female tenure by the average female probability.

The average-female-company-tenure metric is indicative of the average tenure of female workers of a particular company at a particular period-of-time that the female workers have accrued at that particular company. That is, the average-female-career-tenure metric is indicative of how well the company retains female workers. The processor(s) 110 are configured to calculate a metric value for the average-female-company-tenure by (1) identifying a company tenure and a female probability for each individual associated with a company at the corresponding period-of-time, (2) calculating a female tenure for each individual by multiplying the respective company tenure and the respective female probability, (3) calculating an average female tenure among the individuals at the company for the corresponding period-of-time, (4) calculating an average female probability among the individuals at the company for the corresponding period-of-time, and (5) weighting the average female tenure by dividing the average female tenure by the average female probability.

The average-female-role-tenure metric is indicative of the average tenure of female workers in their respective positions at a particular company at a particular period-of-time. That is, the average-female-role-tenure metric is indicative of how well the company promotes and/or creates career paths for its female workers. The processor(s) 110 are configured to calculate a metric value for the average-female-role-tenure by (1) identifying a role tenure and a female probability for each individual associated with a company at the corresponding period-of-time, (2) calculating a female tenure for each individual by multiplying the respective role tenure and the respective female probability, (3) calculating an average female tenure among the individuals at the company for the corresponding period-of-time, (4) calculating an average female probability among the individuals at the company for the corresponding period-of-time, and (5) weighting the average female tenure by dividing the average female tenure by the average female probability.

The average-female-experience-tenure metric is indicative of the average contiguous tenure of female workers of a particular company at a particular period-of-time that the female workers have accrued contiguously at that particular company. That is, the average-female-career-tenure metric is indicative of how well the company retains its female workers. The processor(s) 110 are configured to calculate a metric value for the average-female-experience-tenure by (1) identifying an experience tenure and a female probability for each individual associated with a company at the corresponding period-of-time, (2) calculating a female tenure for each individual by multiplying the respective experience tenure and the respective female probability, (3) calculating an average female tenure among the individuals at the company for the corresponding period-of-time, (4) calculating an average female probability among the individuals at the company for the corresponding period-of-time, and (5) weighting the average female tenure by dividing the average female tenure by the average female probability.

The average-female-industry-tenure metric is indicative of the average tenure of female workers of a particular company at a particular period-of-time that the female workers have accrued for the industry classification that corresponds with the particular company. That is, the average-female-industry-tenure metric is indicative of a level of experience and/or seniority of its female workforce of a company within the industry of the company. The processor(s) 110 are configured to calculate a metric value for the average-female-industry-tenure by (1) identifying an experience tenure and a female probability for each individual associated with a company at the corresponding period-of-time, (2) calculating a female tenure for each individual by multiplying the respective industry tenure and the respective female probability, (3) calculating an average female tenure among the individuals at the company for the corresponding period-of-time, (4) calculating an average female probability among the individuals at the company for the corresponding period-of-time, and (5) weighting the average female tenure by dividing the average female tenure by the average female probability.

Additionally or alternatively, the diversity and/or gender-equity data of company-tenure metric data may include other tenure metrics related to other characteristics of diversity and/or equity. For example, the processor(s) 110 may calculate an average-male-career-tenure metric, an average-male-company-tenure metric, an average-male-role-tenure metric, an average-male-experience-tenure metric, and/or an average-male-industry-tenure metric. The processor(s) 110 may calculate the male-based company-tenure metric data by considering only the tenures of individuals of a particular company that are likely to be a male worker based on the respective male probabilities of those individuals.

Turning to the remaining databases of the benchmarking system 100, the benchmark database 180 is configured to store data associated with benchmark companies of the reference company 275. The processor(s) 110 are configured to select benchmark companies for the reference company 275 and store benchmarking data associated with the benchmark companies in the benchmark database 180. The processor(s) 110 are configured to generate the benchmarking data of the benchmark companies based on the social media data stored in the social media database(s) 150 and the employment date data stored in the date database 160.

In some examples, the reference company 275 and the benchmark companies are entire companies. In such examples, the processor(s) 110 are configured to select entire companies as benchmark companies. Additionally or alternatively, each of the reference company 275 and the benchmark companies may be a particular group-of-interest within a company, such as a department, a seniority position, a region, a seniority position in a department, etc. In such examples, the processor(s) 110 are configured to select departments within companies, seniority positions within companies, regions in which portions of companies are located, seniority positions in departments of companies, etc. as benchmark companies.

For each period-of-time (e.g., a 1-month period) within a period-of-interest (e.g., a 6-month period), the processor(s) 110 are configured to select benchmark companies for the reference company 275 based on an industry of the reference company 275, the period-of-time within the period-of-interest, and/or a headcount of the reference company 275 at that period-of-time. For example, the processor(s) 110 are configured to select peer companies of the reference company 275 and then select the benchmark companies from the pool of peer companies.

Before selecting the benchmark companies for the reference company 275, the processor(s) 110 are configured to identify one or more metrics-of-interest for comparing the reference company 275 to benchmark companies. A metric-of-interest may be any metric for which data is stored in the metric database 170. In some examples, the metric(s)-of-interest are selected by the reference company 275 and/or by an operator of the benchmarking system 100.

The processor(s) 110 also are configured to determine historical headcounts for the companies included in the social media data before selecting the benchmark companies for the reference company 275. In some examples, the social media data collected from the third-party vendor 250 and/or directly from the social media platform 200 includes the current self-reported headcount of companies (e.g., included in the company profile on the social media platform 200) but does not include historical self-reported headcounts of those same companies. As a result, the self-reported headcounts may not be used to identify benchmark companies if the period-of-interest is in the past. In turn, the processor(s) 110 are configured to estimate historical headcounts for companies at historical periods-of-time and store those historical headcounts in the benchmark database 180 for subsequent use.

To estimate the historical headcounts, the processor(s) 110 collect the self-reported current headcounts of the companies from the company data of the social media data. The processor(s) 110 also identify, based on the employment data of the social media data, the number of individuals for each period-of-time that self-report on the social media platform 200 as working for those companies. That is, for each company on the social media platform 200, the processor(s) 110 are configured to identify (1) the self-reported current headcount of the company and (2) the number of individuals, both currently and historically, that have working for the company in their respective social media profiles.

Using the collected data, the processor(s) 110 are configured to calculate a respective headcount signal score for each company. The headcount signal score is a ratio between the self-reported current headcount of a company and the number of individuals self-identifying as being currently employed by that same company. The headcount signal score is indicative of what portion of a company's workforce identifies itself on the social media platform 200. The processor(s) 110 are subsequently configured to use the headcount signal scores to calculate the historical headcounts for companies at historical periods-of-time. More specifically, to calculate a historical headcount for a company at a historical period-of-time, the processor(s) 110 are configured to multiply the headcount signal score of the company by the number of individuals self-identifying as having been employed by that company at that historical period-of-time. The benchmark database 180 is configured to store the historical headcounts generated by the processor(s) 110.

Further, in some examples, the processor(s) 110 are configured to group the headcounts into buckets based on their size. Example buckets include 1-5 individuals, 6-10 individuals, 11-15 individuals, 16-20 individuals, 21-30 individuals, 31-40 individuals, 41-50 individuals, 51-100 individuals, 101-200 individuals, 201-300 individuals, 301-400 individuals, 401-500 individuals, 501-600 individuals, 601-800 individuals, 801-1000 individuals, 1000+ individuals, etc. The benchmark database 180 is configured to store data indicative of the corresponding bucket for each headcount value.

To select the benchmark companies for the reference company 275, the processor(s) 110 are configured to identify other companies that are similar to reference company 275 based on a period-of-interest, its headcount(s) during the period-of-interest, and its industry. The processor(s) 110 are configured to identify companies that are in the same industry as the reference company 275. For example, the processor(s) 110 are configured to identify, based on the classification data stored in the metric database 170, companies that are in the same industry subcategory (“Industry 2”) as the reference company 275. If not enough companies (e.g., less than 20 companies) remain, the processor(s) 110 are configured to alternatively select benchmark companies by identifying which companies are in the same industry category (“Industry 1”) as the reference company 275.

Additionally, the processor(s) 110 are configured to identify a period-of-interest for the benchmarking. The period-of-interest includes one or more period(s)-of-time. In some examples, the period-of-interest is selected by the reference company 275 and/or by an operator of the benchmarking system 100. The processor(s) 110 are configured to then identify companies that have a similar headcount to that of the reference company 275 for a corresponding period-of-time. For example, the processor(s) 110 are configured to identify the companies that are in the same headcount bucket as the reference company 275 for a corresponding period-of-time.

In turn, the processor(s) 110 are configured to select benchmark companies based on those companies that match (1) the industry of the reference company 275 and (2) the headcount(s) of the reference company 275 during a corresponding period-of-time.

In some examples, the processor(s) 110 are configured to identify any company that matches the industry and headcount(s) of the reference company 275 as a peer company. The processor(s) 110 are then configured to select the benchmark companies from the peer companies by culling outlier peer companies. For example, the processor(s) 110 may prevent any company that has a headcount signal score of less than a lower signal-score threshold (e.g., 0.1) or greater than an upper signal-score threshold (e.g., 1.0) from selection as a benchmark company. Additionally or alternatively, the processor(s) 110 may prevent any company that has a metric score for a metric-of-interest below a lower percentile (e.g., the lower 3%) or above a lower percentile (e.g., the upper 3%) from selection as a benchmark company. In other examples, the processor(s) 110 may remove one or more peer companies as a benchmark company based on a distribution of the metric values using percentile buckets. Further, in some examples, the processor(s) 110 may remove one or more peer companies as a benchmark company based on custom-defined rules. The processor(s) 110 are then configured to select the remaining peer companies as benchmark companies.

The benchmark database 180 is configured to store data associated with the benchmark companies of the reference company 275. For example, the benchmark database 180 is configured to store metric values of the benchmark companies for the metric(s)-of-interest. In some examples, the processor(s) 110 are configured to calculate a mean and a standard deviation of the benchmark companies for each metric-of-interest, and the benchmark database 180 is configured to store the mean and the standard deviation. As detailed below, the mean and standard deviation of the benchmark companies for a metric-of-interest are subsequently used to calculate one or more index scores associated with the reference company 275. In other examples, the processor(s) 110 are configured to store the distribution of the benchmark companies for each metric-of-interest using percentile buckets.

The index score database 190 is configured to store one or more index scores of the reference company 275 that are generated by the processor(s) 110 for one or more metrics-of-interest. The index scores facilitate the assessment of past performance and/or the prediction of future performance of companies (e.g., the reference company 275, benchmark companies, etc.) and/or individuals (e.g., employees of the reference company 275) relative to other similar companies within the same industry (e.g., benchmarks). Example index scores include a company index score of the reference company 275, individual index scores of workers of the reference company 275, and a collective index score of the reference company 275.

A company index score of a company, such as the reference company 275, is indicative of the past performance of that company compared to its benchmark companies in light of a corresponding metric-of-interest. Such an assessment of the past performance of a company may facilitate predicting the future performance of that company, especially for a company that consistently overperforms or underperforms compared to its identified benchmarks.

The processor(s) 110 are configured to calculate a company index score for a respective company for each period-of-time (e.g., a 1-month period) within a period-of-interest (e.g., a 6-month period) for one or more metrics-of-interest. The processor(s) 110 are configured to calculate a company index score for an entire company and/or a particular group-of-interest within a company, such as a department, a seniority position, a region, a seniority position in a department, etc. Additionally, the processor(s) 110 are configured to calculate the company index score for a normal and/or non-normal distribution of the benchmark companies of the reference company 275.

For a normal distribution, the processor(s) 110 are configured to calculate a company index score using a z-score and/or a percentile rank. For example, the processor(s) 110 are configured to calculate a z-score based on (1) a metric value of the reference company 275, (2) the mean of the benchmark companies, and (3) the standard deviation of the benchmark companies for a corresponding period-of-time and metric-of-interest. In particular, the processor(s) 110 are configured to calculate a z-score by dividing the difference between the metric value of the reference company 275 and the mean of the benchmark companies by the standard deviation of the benchmark companies. The processor(s) 110 are then configured to convert the z-score to a percentile rank and assign the percentile rank as the company index score for the reference company 275 for the corresponding period-of-time and metric-of-interest.

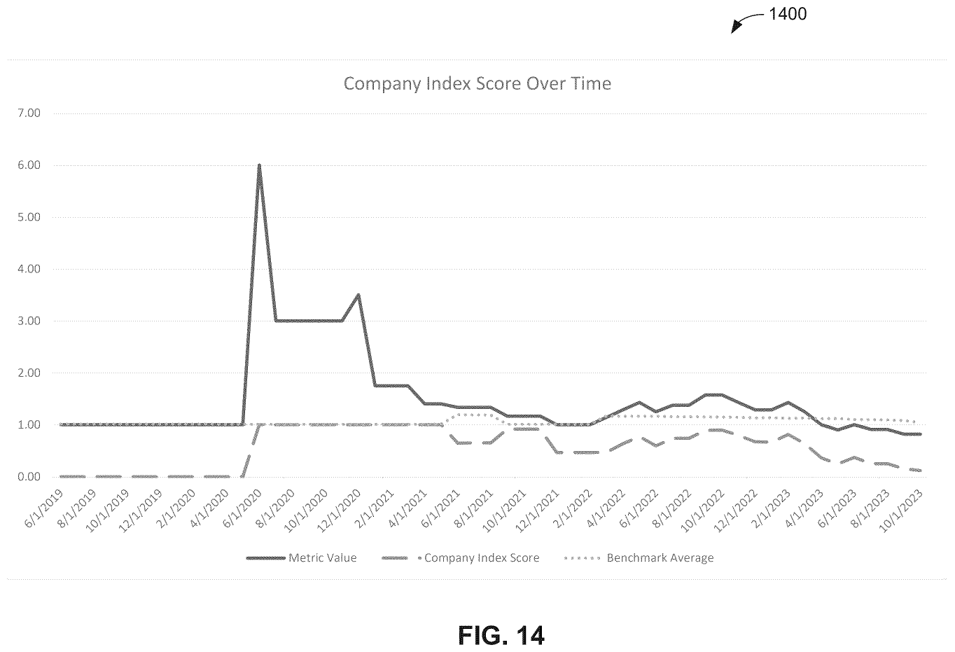

FIG. 14 is a chart 1400 depicting a company index score for a company over time. The chart 1400 includes a solid line that depicts a metric value of a metric-of-interest for the company at different periods-of-time. A dotted line depicts the mean of the benchmark companies at different periods-of-time. A dashed line depicts a company index score of the company at different periods-of-time.

For a non-normal distribution, the processor(s) 110 are configured to calculate using buckets of metric values for the metric-of-interest. For example, the processor(s) 110 are configured to assign the reference company 275 and each benchmark company to a corresponding bucket based on a metric value of the benchmark company for the metric-of-interest. The processor(s) 110 are then configured to calculate a percentile rank for the reference company 275 based on (1) the distribution among the buckets and (2) which bucket the reference company 275 is assigned. The processor(s) 110 are configured to assign the percentile rank as the company index score for the reference company 275 for the corresponding period-of-time and metric-of-interest.

An individual index score of an individual is indicative of a career performance of a corresponding individual and reflects the performance of companies while the individual worked at those companies. The individual index score of an individual uses the company index scores of the companies at which the individual worked as a proxy to determine the past performance of that individual. Such an assessment of the past performance of an individual (e.g., a CEO) may facilitate predicting the future performance of that individual and/or the future performance of a company at which the individual currently works, especially if that individual has consistently overperformed or underperformed in the past.

The processor(s) 110 are configured to calculate an individual index score for a respective individual for each period-of-time (e.g., a 1-month period) in their employment history during which the individual works for a company (e.g., as a job, as an owner, etc.). The processor(s) 110 are configured to calculate an individual index score for an individual at a period-of-time based on each company index score that corresponds with a respective period-of-time of employment of the individual. That is, to calculate an individual index score for a particular period-of-time for an individual, the processor(s) 110 are first configured to identify a respective company index score for that particular period-of-time and for each preceding period-of-time in the employment history of the individual. The processor(s) 110 are then configured to use those identified company index scores to determine the individual index score for the individual for that period-of-time.

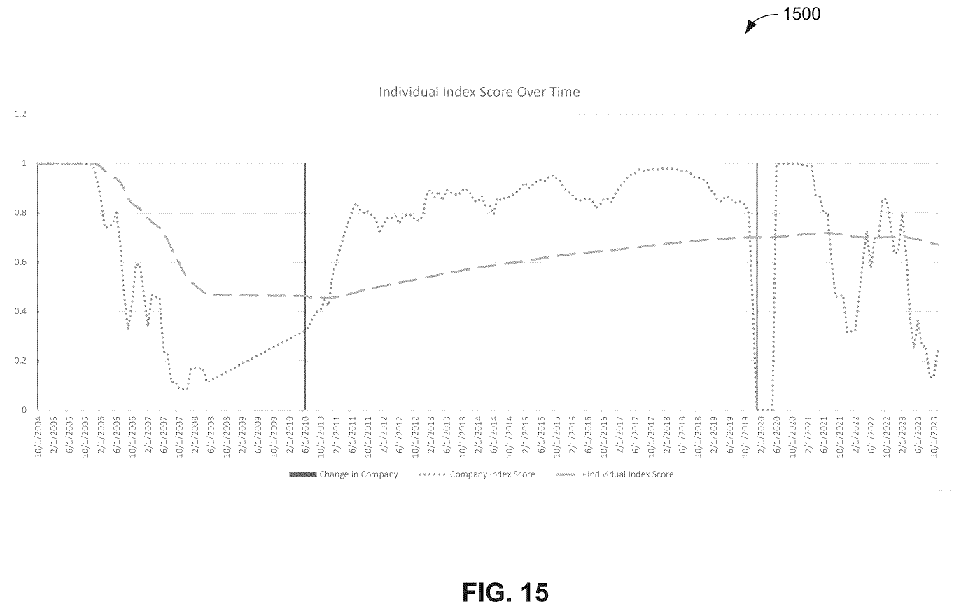

FIG. 15 is a chart 1500 depicting an individual index score over time. The chart 1500 includes vertical lines that depict a change in company for an individual. A dotted line depicts company index scores that correspond with respective period-of-times of employment of the individual. A dashed line depicts an individual index score of the individual at different periods-of-time.

For example, the processor(s) 110 are configured to calculate a running geometric mean of the identified company index scores associated with the employment history of the individual and assign the running geometric mean as the individual index score. In some examples, the processor(s) 110 are configured to calculate a running geometric mean with a time decay and assign the running geometric mean with the time decay as the individual index score. The running geometric mean may be time decayed such that a 5-year-old company index score is weighted at 50% compared to the company index score of the period-of-time for which the individual index score is being calculated. Additionally or alternatively, the running geometric mean may be time decayed such that a 10-year-old company index score is weighted at 30% compared to the company index score of the period-of-time for which the individual index score is being calculated.

Experiences such as an advisor, a board member, and/or a student within an employment history of an individual may be excluded from consideration by the processor(s) 110 when calculating an individual index score for that individual. Further, in some instances, an employment history of an individual may indicate that the individual held two or more different positions at the same time. In such instances, the processor(s) 110 may be configured to pick only one of those positions for the respective period-of-time to prevent assigning two different individual index scores to the individual for one period-of-time. The processor(s) 110 are configured to pick which of the overlapping positions to use for determining the corresponding individual index score based on a predefined set of rules (e.g., prioritize for-profit organizations over non-profit organizations, then prioritize based on date, then prioritize based on the size of the company, etc.).

Additionally, the processor(s) 110 are configured to calculate an individual index score at a company level and/or at a level for a particular group-of-interest within a company, such as a department, a seniority position, a region, a seniority position in a department, etc. In some examples in which a particular group within a company is of interest, the processor(s) 110 may use a company index score of the entire company and not the group-of-interest if the individual is associated within departments at a high enough level (e.g., the Executive level) and/or if it is unclear with which group-of-interest the individual is associated.

A collective index score of a company is indicative of average career performance of individuals that currently work for the company. That is, the collective index score takes into account the past performance of its current workers. The collective index score of a company uses the individual index scores of its current workers as a proxy to determine current and/or future performance of the company with those individuals. In turn, the collective index score may be indicative of the current performance of the corresponding company and/or a particular group-of-interest within a company and may be predictive of future performance, which is particularly beneficial since there is oftentimes a considerable lag between current actions of a company and subsequent performance within a corresponding industry.

The processor(s) 110 are configured to calculate a collective index score for a respective company for a period-of-time by (1) identifying individuals that work for the company during that period-of-time, (2) identifying the respective individual index score for each of those individuals working for the company, (3) determining the mean and/or the standard deviation of those individual index scores, and (4) assigning the calculated mean as the collective index score. In some examples, the processor(s) 110 are configured to calculate a weighted mean of the individual index scores that gives greater weight to one or more particular groups-of-interest and subsequently assign the weighted mean as the collective index score. The processor(s) 110 are configured to calculate a collective index score be for an entire company and/or for a particular group-of-interest within a company, such as a department, a seniority position, a region, a seniority position in a department, etc.

The processor(s) 110 are further configured to generate a report with graphs, charts, and/or tables that convey an assessed and/or predicted performance of the reference company 275 relative to the benchmark companies based on the company, individual, and/or collective index scores. Upon generating the report, the processor(s) 110 are configured to transmit the report to the reference company 275 and/or another interested party (e.g., via an email, a text message, a link, a notification, etc.).

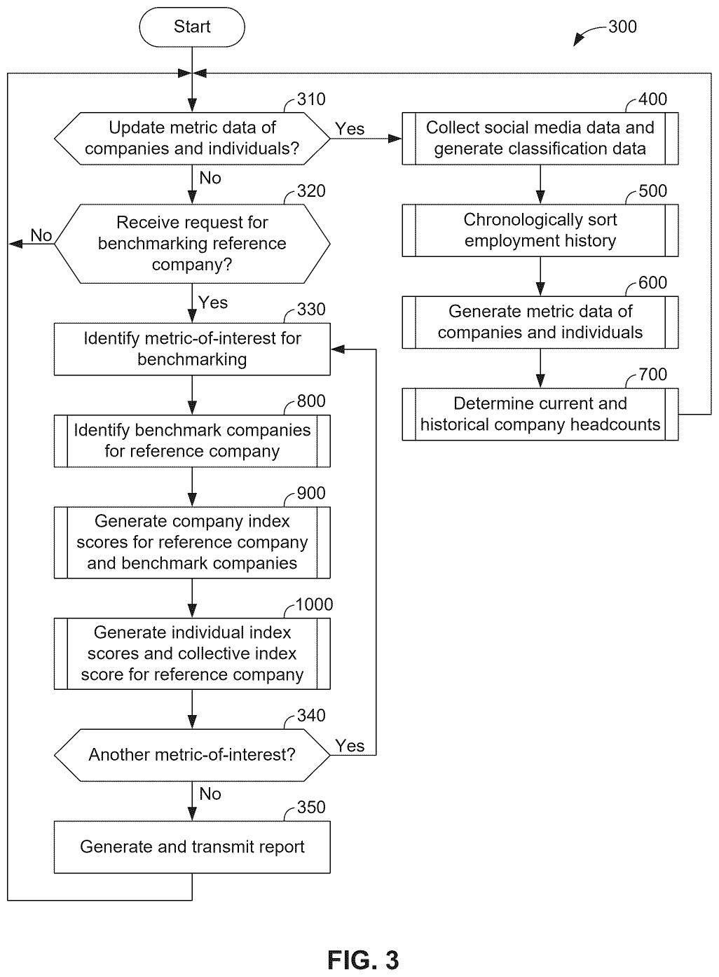

FIG. 3 is a flowchart of an example method 300 for the benchmarking system 100 to assess and/or predict performance of companies based on social media content. The flowchart of FIG. 3 is representative of machine readable instructions that are stored in memory (such as the memory 120 of FIG. 2) and include one or more programs which, when executed by one or more processors (such as the processor(s) 110 of FIG. 2), cause the benchmarking system 100 to assess and/or predict the performance of companies. While the example program is described with reference to the flowchart illustrated in FIG. 3, many other methods may alternatively be used. For example, the order of execution of the blocks may be rearranged, changed, eliminated, and/or combined to perform the method 300. Further, because the method 300 is disclosed in connection with the components of FIGS. 1-2, some functions of those components will not be described in detail below.

Initially, at block 310, the processor(s) 110 determine whether it is time to update metric data of companies and/or individuals.

In some examples, the processor(s) 110 update the metric data at a predefined interval (e.g., once a day, once a week, twice a month, etc.). Additionally or alternatively, the processor(s) 110 may update the metric data upon detecting a predefined event, such as identification that the new social media data is available from the third-party vendor 250 and/or directly from the social media platform 200. Further, in some examples, the processor(s) 110 may update the metric data on demand and/or upon receiving a request from the reference company 275 and/or another party. In response to the processor(s) 110 determining that the metric data is to be updated, the method 300 proceeds to block 400 at which the processor(s) 110 collect updated social media data and generate updated classification data.

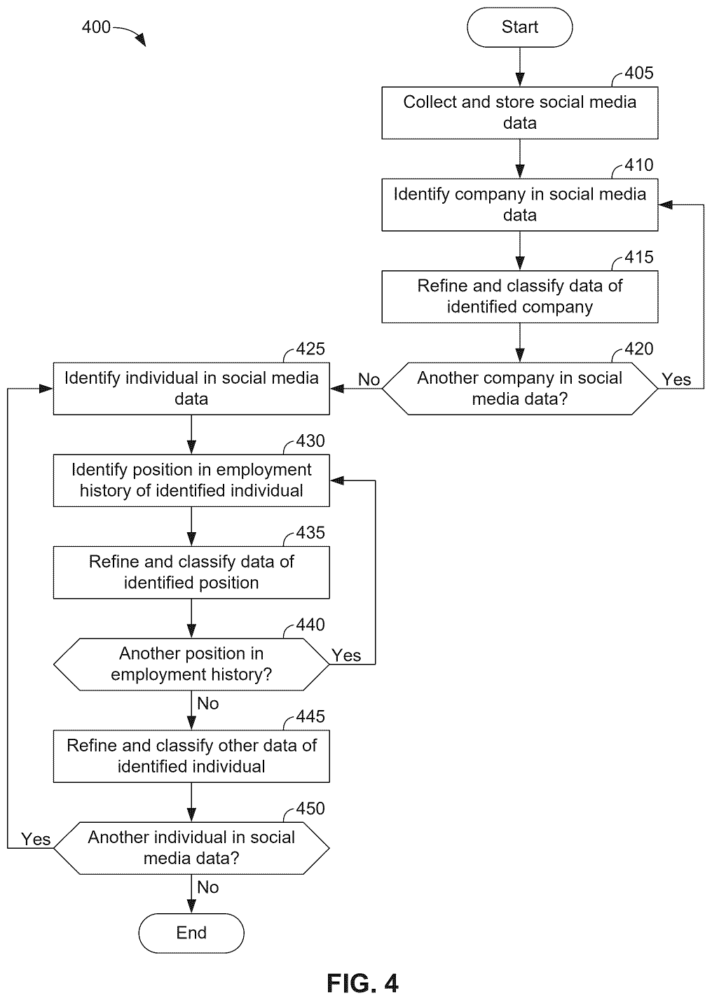

FIG. 4 is a flowchart of an example method 400 for the benchmarking system 100 to execute block 400 of FIG. 3 to collect social media data of individuals and companies and generate classification data. The flowchart of FIG. 4 is representative of machine readable instructions that are stored in memory (such as the memory 120 of FIG. 2) and include one or more programs which, when executed by one or more processors (such as the processor(s) 110 of FIG. 2), cause the benchmarking system 100 to collect social media data and generate classification data. While the example program is described with reference to the flowchart illustrated in FIG. 4, many other methods may alternatively be used. For example, the order of execution of the blocks may be rearranged, changed, eliminated, and/or combined to perform the method 400. Further, because the method 400 is disclosed in connection with the components of FIGS. 1-2, some functions of those components will not be described in detail below.

Initially, at block 405, the processor(s) 110 collect social media data from the third-party vendor 250 and/or directly from the social media platform 200. The processor(s) 110 further store the collected social media data in the social media database(s) 150. For example, the processor(s) 110 store collected social media data of companies (“company data”) in the company database 152, store collected social media data of individuals (“individual data”) in the individual database 154, and store collected social media data indicative of employment histories of individuals (“employment data”) in the employment database 156.

At block 410, the processor(s) 110 identify a company included in the social media data. At block 415, the processor(s) 110 refine the social media data associated with the identified company. For example, the processor(s) 110 clean and/or annotate the collected company data. In some examples, the processor(s) 110 clean and/or annotate the collected company data by removing stop words and/or punctuation from data entries, translating collected text into a preselected language (e.g., English), and/or and annotating the field with “valid” or “invalid” based on information included in the field. Additionally, the processor(s) 110 classify and/or supplement portion(s) of the company data. For example, the processor(s) 110 convert a headquarters location initially expressed in text into a latitudinal and longitudinal coordinate, assign one or more level(s) of geographic granularity to the corresponding company, and/or assign an industry category (“Industry 1”) and/or an industry subcategory (“Industry 2”) to the identified company.

At block 420, the processor(s) 110 determine whether there is another company included in the collected social media data to review. In response to the processor(s) 110 determining that there is another company, the method 400 returns to block 410. Otherwise, in response to the processor(s) 110 determining that there is not another company to review, the method 400 proceeds to block 425 at which the processor(s) 110 identify an individual included in the social media data.

At block 430, the processor(s) 110 identify a position within the employment history of the identified individual. At block 435, the processor(s) 110 refine the social media data associated with the identified employment position held by the identified individual. For example, the processor(s) 110 clean and/or annotate the collected employment data associated with the identified employment position. In some examples, the processor(s) 110 clean and/or annotate the collected employment data by removing stop words and/or punctuation from data entries, translating collected text into a preselected language (e.g., English), annotating the field with “valid” or “invalid,” and/or converting a date entry from text form (e.g., February 2005) to date form (e.g., 2005 Feb. 1). Additionally, the processor(s) 110 classify and/or supplement portion(s) of the employment data. For example, the processor(s) 110 may classify a job title of employment position by department, seniority, and/or work type. The processor(s) 110 may also further aggregate the assigned department into a category and subcategory.

At block 440, the processor(s) 110 determine whether there is another employment position included in the employment history of the identified individual. In response to the processor(s) 110 determining that there is another employment position, the method 400 returns to block 430. Otherwise, in response to the processor(s) 110 determining that there is not another employment position to review for the identified individual, the method 400 proceeds to block 445.

At block 445, the processor(s) 110 refine other social media data associated with the identified individual. For example, the processor(s) 110 clean and/or annotate the collected individual data of the identified individual. In some examples, the processor(s) 110 clean and/or annotate the collected employment data by removing stop words and/or punctuation from data entries, translating collected text into a preselected language (e.g., English), and/or annotating the field with “valid” or “invalid.” Additionally, the processor(s) 110 classify and/or supplement portion(s) of the individual data. For example, the processor(s) 110 may convert a residence location expressed in text into a latitudinal and longitudinal coordinate, assign one or more level(s) of geographic granularity, and/or assign a gender probability.

At block 450, the processor(s) 110 determine whether there is another individual included in the collected social media data to review. In response to the processor(s) 110 determining that there is another individual, the method 400 returns to block 425. Otherwise, in response to the processor(s) 110 determining that there is not another individual to review, the method 400 for collecting social media data and generating classification data ends.

In FIG. 4, the blocks are depicted as being performed by the processor(s) 110 in a sequential manner. However, the blocks may be performed by the processor(s) 110 nearly simultaneously such that the social media data is collected and the classification data is generated all at once.

Returning to FIG. 3, the method 300 for assessing and/or predicting company performance proceeds to block 500 upon completing block 400. At block 500, the processor(s) 110 chronologically sort employment history based on social media data.

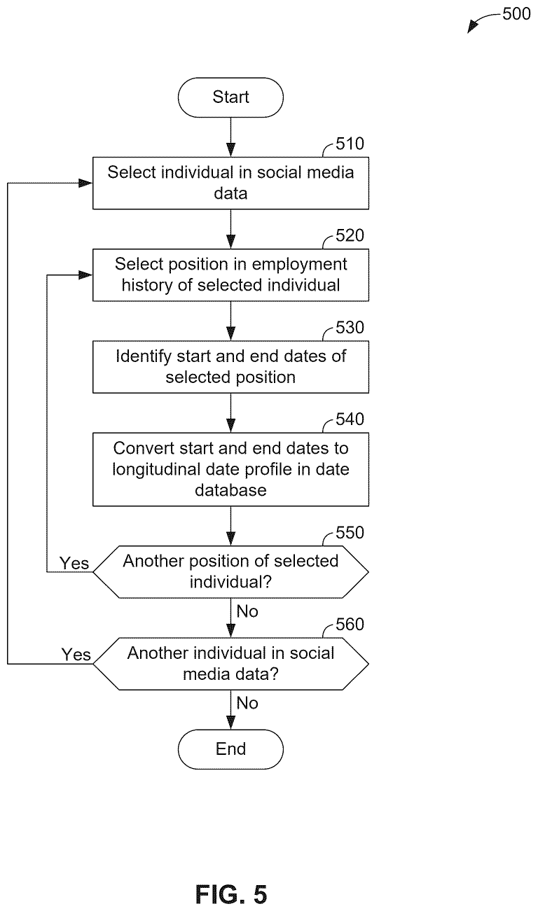

FIG. 5 is a flowchart of an example method 500 for the benchmarking system 100 to execute block 500 of FIG. 3 to chronologically sort employment history based on social media data. The flowchart of FIG. 5 is representative of machine readable instructions that are stored in memory (such as the memory 120 of FIG. 2) and include one or more programs which, when executed by one or more processors (such as the processor(s) 110 of FIG. 2), cause the benchmarking system 100 to chronologically sort employment history. While the example program is described with reference to the flowchart illustrated in FIG. 5, many other methods may alternatively be used. For example, the order of execution of the blocks may be rearranged, changed, eliminated, and/or combined to perform the method 500. Further, because the method 500 is disclosed in connection with the components of FIGS. 1-2, some functions of those components will not be described in detail below.

Initially, at block 510, the processor(s) 110 select an individual included in the social media data. At block 520, the processor(s) 110 select an employment position held by the individual that is included in the employment history of the selected individual. At block 530, the processor(s) identify a start date and an end date during which the selected individual held the selected employment position. At block 540, the processor(s) convert the start and end dates into a longitudinal date profile and store the longitudinal date profile as a record in the date database 160. In some examples, the longitudinal date profile extends between the “start date” and the “end date+1 additional period-of-time” to facilitate subsequent analysis of attrition headcount metric(s).

At block 550, the processor(s) 110 determine whether there is another employment position in the employment history of the selected individual. In response to the processor(s) 550 determining that there is another employment position, the method 500 returns to block 520. Otherwise, in response to the processor(s) 110 determining that there is no other employment position, the method 500 proceeds to block 560 at which the processor(s) 110 determine whether there is another individual in the social media data. In response to the processor(s) 550 determining that there is another individual, the method 500 returns to block 510. Otherwise, in response to the processor(s) 110 determining that there is no other individual, the method 500 for chronologically sorting employment history ends.

In FIG. 5, the blocks are depicted as being performed by the processor(s) 110 in a sequential manner. However, the blocks may be performed by the processor(s) 110 nearly simultaneously such that the employment history is chronologically sorted all at once.

Returning to FIG. 3, the method 300 for assessing and/or predicting company performance proceeds to block 600 upon completing block 500. At block 600, the processor(s) 110 generate updated metric data of companies and individuals.

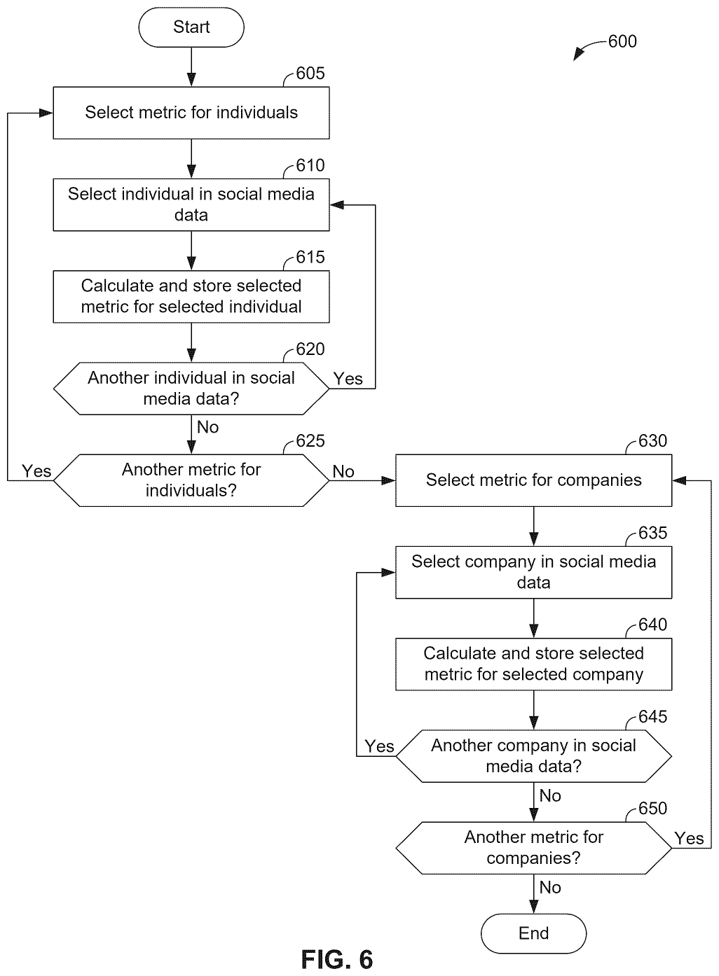

FIG. 6 is a flowchart of an example method 400 for the benchmarking system 100 to execute block 400 of FIG. 3 to generate metric data of companies and individuals. The flowchart of FIG. 4 is representative of machine readable instructions that are stored in memory (such as the memory 120 of FIG. 2) and include one or more programs which, when executed by one or more processors (such as the processor(s) 110 of FIG. 2), cause the benchmarking system 100 to generate metric data. While the example program is described with reference to the flowchart illustrated in FIG. 6, many other methods may alternatively be used. For example, the order of execution of the blocks may be rearranged, changed, eliminated, and/or combined to perform the method 600. Further, because the method 600 is disclosed in connection with the components of FIGS. 1-2, some functions of those components will not be described in detail below.

Initially, at block 605, the processor(s) 110 select a metric for individuals. Example metrics for individuals include individual-tenure metrics, such as a career-tenure metric, a company-tenure metric, a role-tenure metric, an experience-tenure metric, and/or an industry-tenure metric.

At block 610, the processor(s) 110 select an individual included in the social media data. At block 615, the processor(s) 110 calculate a metric score of the selected metric for the selected individual. Additionally, the processor(s) store the calculated metric score in the metric database 170. At block 620, the processor(s) 110 determine whether there is another individual in the social media data for which to calculate a metric value for the selected metric. In response to the processor(s) 110 determining that there is another individual, the method 600 returns to block 610. Otherwise, in response to the processor(s) 110 determining that there is no other individual, the method proceeds to block 625.

At block 625, the processor(s) 110 determine whether there is another metric for which to calculate and store metric values for individuals. In response to the processor(s) 110 determining that there is another metric for individuals, the method 600 returns to block 605. Otherwise, in response to the processor(s) 110 determining that there is no other metric for individuals, the method 600 proceeds to block 630.

At block 630, the processor(s) 110 select a metric for companies. Example metrics for companies include headcount metrics, such as a total-headcount metric, a new-headcount metric, a lost-headcount metric, and/or a retained-headcount metric. Headcount metrics also include time-interval metrics, such as a net-headcount-growth metric, an addition-rate metric, an attrition-rate metric, and/or a growth-efficiency metric. Headcount metrics also include diversity and/or gender-equity metrics, such as a female/male-probability-average metric, a total-female/male-headcount metric, a new-female/male-headcount metric, a lost-female/male-headcount metric, and/or a retained-female/male-headcount metric. Other example metrics for companies include company-tenure metrics, such as an average-career-tenure metric, an average-company-tenure metric, an average-role-tenure metric, an average-experience-tenure metric, and/or an average-industry-tenure metric. Company-tenure metrics also includes an average-female/male-career-tenure metric, an average-female/male-company-tenure metric, an average-female/male-role-tenure metric, an average-female/male-experience-tenure metric, and/or an average-female/male-industry-tenure metric.

At block 635, the processor(s) 110 select a company included in the social media data. At block 640, the processor(s) 110 calculate a metric score of the selected metric for the selected company. Additionally, the processor(s) store the calculated metric score in the metric database 170. At block 645, the processor(s) 110 determine whether there is another company in the social media data for which to calculate a metric value for the selected metric. In response to the processor(s) 110 determining that there is another company, the method 600 returns to block 635. Otherwise, in response to the processor(s) 110 determining that there is no other company, the method proceeds to block 650.

At block 650, the processor(s) 110 determine whether there is another metric for which to calculate and store metric values for companies. In response to the processor(s) 110 determining that there is another metric for companies, the method 600 returns to block 630. Otherwise, in response to the processor(s) 110 determining that there is no other metric for companies, the method 600 for generating metric data of companies and individuals ends.

In FIG. 6, the blocks are depicted as being performed by the processor(s) 110 in a sequential manner. However, the blocks may be performed by the processor(s) 110 nearly simultaneously such that the metric data is generated for companies and individuals all at once.

Returning to FIG. 3, the method 300 for assessing and/or predicting company performance proceeds to block 700 upon completing block 600. At block 700, the processor(s) 110 determine current and historical company headcounts.

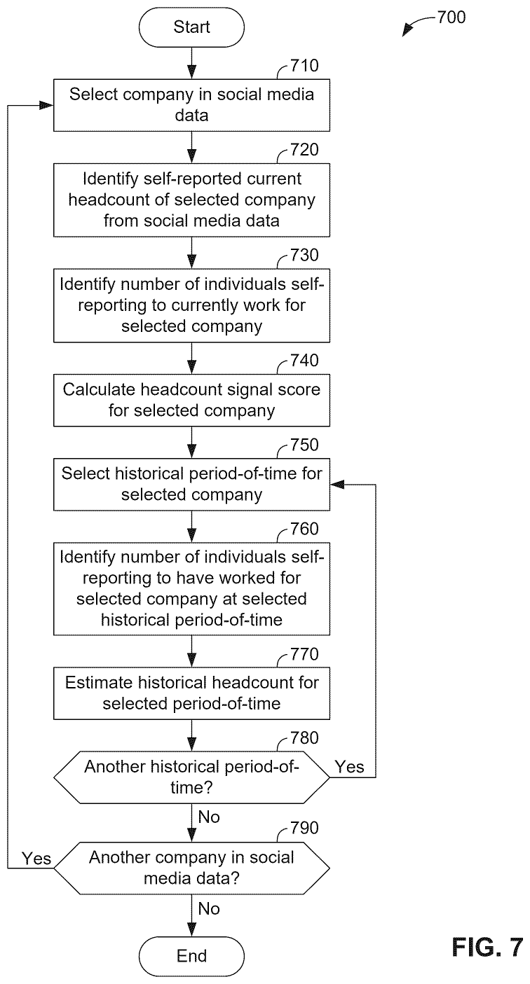

FIG. 7 is a flowchart of an example method 700 for the benchmarking system 100 to execute block 700 of FIG. 3 to determine current and historical headcounts of companies. The flowchart of FIG. 7 is representative of machine readable instructions that are stored in memory (such as the memory 120 of FIG. 2) and include one or more programs which, when executed by one or more processors (such as the processor(s) 110 of FIG. 2), cause the benchmarking system 100 to determine current and historical headcounts of companies. While the example program is described with reference to the flowchart illustrated in FIG. 7, many other methods may alternatively be used. For example, the order of execution of the blocks may be rearranged, changed, eliminated, and/or combined to perform the method 700. Further, because the method 700 is disclosed in connection with the components of FIGS. 1-2, some functions of those components will not be described in detail below.

Initially, at block 710, the processor(s) 110 select a company included in the social media data. At block 720, the processor(s) 110 identify a current self-reported headcount of the selected company in the social media data. At block 730, the processor(s) 110 identify a number of individuals that self-reported to be currently working for the selected company. For example, a company may include its self-reported headcount in its profile on the social media platform 200, and an individual may self-report that they are currently employed by a company within an employment history section of their profile on the social media platform 200.

At block 740, the processor(s) 110 calculate a headcount signal score for the selected individual. The headcount signal score is a ratio between the self-reported current headcount of a company and the number of individuals self-identifying as being currently employed by that same company and is indicative of what portion of a company's workforce identifies itself on the social media platform 200.

At block 750, the processor(s) 110 select a historical period-of-time for the selected company. At block 760, the processor(s) 110 identify a number of individuals that self-reported to be working for the selected company at the selected historical period-of-time. At block 770, the processor(s) 110 estimate a historical headcount for the selected company at the selected historical period-of-time based on the number of individuals identified at block 760 and the headcount signal score calculated at block 740. For example, the processor(s) 110 calculate the historical headcount by multiplying the number of individuals by the headcount signal score. In some examples, the processor(s) 110 further assign the select company to a bucket based on their calculated headcount size (e.g., 1-5, 6-10, 11-15, 16-20, 21-30, 31-40, 41-50, 51-100, 101-200, 201-300, 301-400, 401-500, 501-600, 601-800, 801-1000, 1000+, etc.).

At block 780, the processor(s) 110 determine whether there is another historical period-of-time for which to estimate a historical headcount for the selected company. In response to the processor(s) 110 determining that there is another historical period-of-time, the method 700 returns to block 750. Otherwise, in response to the processor(s) 110 determining that there is no other historical period-of-time for the selected company, the method 700 proceeds to block 790.

At block 790, the processor(s) 110 determine whether there is another company in the social media data for which to estimate historical headcounts. In response to the processor(s) 110 determining that there is another company, the method 700 returns to block 710. Otherwise, in response to the processor(s) 110 determining that there is no other company, the method 700 for determining company headcounts ends.

In FIG. 7, the blocks are depicted as being performed by the processor(s) 110 in a sequential manner. However, the blocks may be performed by the processor(s) 110 nearly simultaneously such that the company headcounts are determined all at once.

Returning to FIG. 3, the method 300 for assessing and/or predicting company performance returns to block 310 upon completing block 700. At block 310, in response to the processor(s) 110 determining that it is not time to update the metric data of companies and individuals, the method proceeds to block 320 at which the processor(s) 110 determine whether a request was received to benchmark a reference company (e.g., the reference company 275).

In response to the processor(s) 110 determining that a request has not been received, the method 300 returns to block 310. Otherwise, in response to determining that a request has been received, the method 300 proceeds to block 330 at which the processor(s) 110 identify metric(s)-of-interest for the benchmarking. The metric(s)-of-interest may be selected by the processor(s) 110, the reference company 275, and/or an operator of the benchmarking system 100. Upon completing block 330, the method 300 proceeds to block 800 at which the processor(s) 110 identify benchmark companies for the reference company 275.

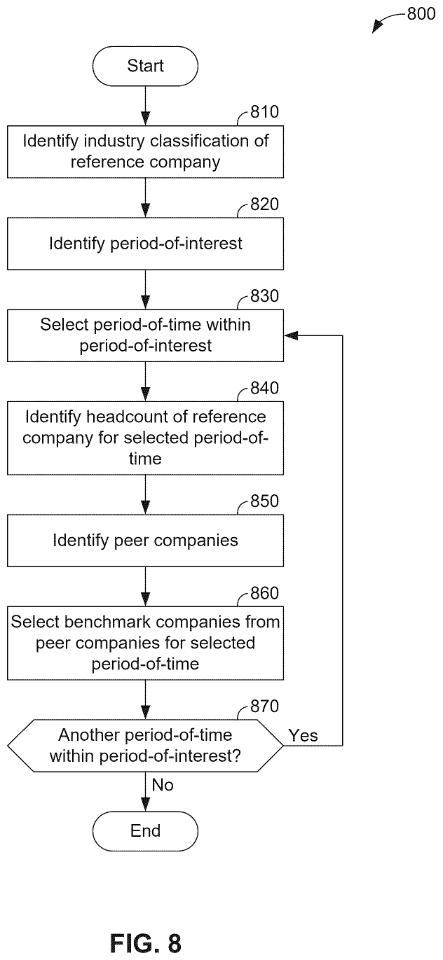

FIG. 8 is a flowchart of an example method 800 for the benchmarking system 100 to execute block 800 of FIG. 3 to identify a set of benchmark companies for a reference company. The flowchart of FIG. 8 is representative of machine readable instructions that are stored in memory (such as the memory 120 of FIG. 2) and include one or more programs which, when executed by one or more processors (such as the processor(s) 110 of FIG. 2), cause the benchmarking system 100 to identify a set of benchmark companies. While the example program is described with reference to the flowchart illustrated in FIG. 8, many other methods may alternatively be used. For example, the order of execution of the blocks may be rearranged, changed, eliminated, and/or combined to perform the method 800. Further, because the method 800 is disclosed in connection with the components of FIGS. 1-2, some functions of those components will not be described in detail below.

Initially, at block 810, the processor(s) 110 identify an industry classification (e.g., an “Industry 2” subclassification, an “Industry 1” classification, etc.”) of the reference company 275. At block 820, the processor(s) 110 identify a period-of-interest for benchmarking analysis. The period-of-interest may include one or more period(s)-of-time. In some examples, the period-of-interest is selected by the reference company 275 and/or by an operator of the benchmarking system 100.

At block 830, the processor(s) 110 are configured to select a period-of-time within the period-of-interest. At block 840, the processor(s) identify the headcount of the reference company for the selected period-of-time. For example, the identified headcount may be self-reported current headcount identified at block 720 of FIG. 7 or a historical headcount estimated at block 780 of FIG. 7.

Returning to FIG. 8, the processor(s) 110 identify, at block 850, peer companies for the reference company 275 at the selected period-of-time. For example, the processor(s) 110 identify a company as a peer company of the reference company 275 if that company (1) has the same industry classification as the reference company 275 and (2) has a similar headcount to that of the reference company for the selected period-of-time. In some examples, the processor(s) 110 identify a company as having a similar headcount to that of the reference company 275 if that company has been assigned to the same headcount bucket as the reference company 275 for the selected period-of-time.

At block 860, the processor(s) 110 select benchmark companies from the identified peer companies for the selected period-of-time. In some examples, the processor(s) 110 identify any peer company as a benchmark company. In other examples, the processor(s) 110 select only a portion of the peer companies as benchmark companies by culling outlier peer companies. For example, the processor(s) 110 may prevent any company that has a headcount signal score of less than a lower signal-score threshold (e.g., 0.1) or greater than an upper signal-score threshold (e.g., 1.0) from selection as a benchmark company. Additionally or alternatively, the processor(s) 110 may prevent any company that has a metric score for a metric-of-interest below a lower percentile (e.g., the lower 3%) or above a lower percentile (e.g., the upper 3%) from selection as a benchmark company. The processor(s) 110 may also remove one or more peer companies as a benchmark company based on custom-defined rules.

At block 870, the processor(s) 110 determine whether there is another period-of-time within the period-of-interest to identify benchmark companies for the reference company 275. In response to the processor(s) 110 determining that there is another period-of-time, the method 800 returns to block 830. Otherwise, in response to the processor(s) 110 determining that there is no other period-of-time, the method 800 for identifying benchmark companies ends.

In FIG. 8, the blocks are depicted as being performed by the processor(s) 110 in a sequential manner. However, the blocks may be performed by the processor(s) 110 nearly simultaneously such that the benchmark companies are identified all at once.

Returning to FIG. 3, the method 300 for assessing and/or predicting company performance proceeds to block 900 upon completing block 800. At block 900, the processor(s) 110 determine company index scores.

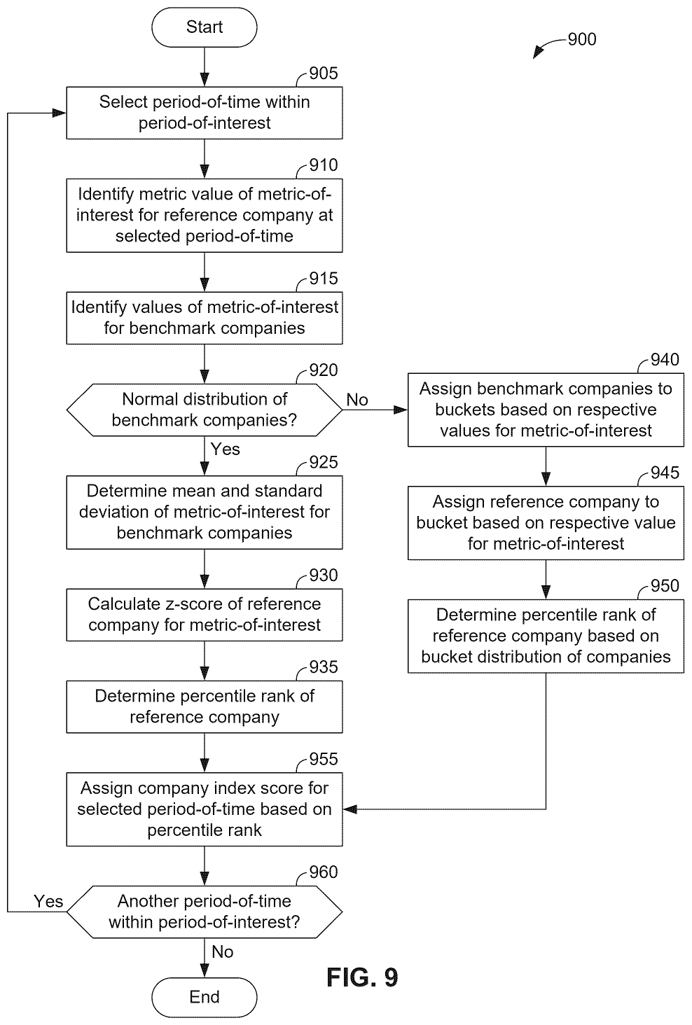

FIG. 9 is a flowchart of an example method 900 for the benchmarking system 100 to execute block 800 of FIG. 3 to determine a company index score for a reference company. The flowchart of FIG. 9 is representative of machine readable instructions that are stored in memory (such as the memory 120 of FIG. 2) and include one or more programs which, when executed by one or more processors (such as the processor(s) 110 of FIG. 2), cause the benchmarking system 100 to identify a set of benchmark companies. While the example program is described with reference to the flowchart illustrated in FIG. 9, many other methods may alternatively be used. For example, the order of execution of the blocks may be rearranged, changed, eliminated, and/or combined to perform the method 900. Further, because the method 900 is disclosed in connection with the components of FIGS. 1-2, some functions of those components will not be described in detail below.

Initially, at block 905, the processor(s) 110 select a period-of-time within the period-of-interest identified at block 820 of FIG. 8. At block 910 of FIG. 9, the processor(s) 110 identify the metric value of the metric-of-interest for the reference company 275 at the selected period-of-time. At block 915, the processor(s) 110 identify metric values of the metric-of-interest for the benchmark companies of the reference company 275 at the selected period-of-time. For example, the metric-of-interest is identified at block 330 of FIG. 3, and the metric values of the metric-of-interest are generated at block 640 of FIG. 6.

At block 920, the processor(s) 110 determine whether the benchmark companies have a normal distribution of metric values for the metric-of-interest at the selected period-of-time. That is, the processor(s) 110 determine whether there is a normal distribution or non-normal distribution of metric values for the metric-of-interest among the benchmark companies.

In response to the processor(s) 110 determining that there is not a normal distribution (i.e., that the distribution is non-normal) of benchmark companies for the metric-of-interest, the method 900 proceeds to block 925 at which the processor(s) 110 determine a mean and a standard deviation of the metric values of the metric-of-interest for the benchmark companies. At block 930, the processor(s) 110 calculate a z-score of the reference company 275 for the metric-of-interest. For example, the processor(s) 110 calculate a z-score of the reference company 275 based on (1) the metric value of the reference company 275, (2) the mean of the benchmark companies, and (3) the standard deviation of the benchmark companies. In particular, the processor(s) 110 calculate the z-score by dividing the difference between the metric value of the reference company 275 and the mean of the benchmark companies by the standard deviation of the benchmark companies. At block 935, the processor(s) 110 determine the percentile rank of the reference company 275. For example, the processor(s) 110 determine the percentile rank by converting the z-score to a percentile rank. Upon completing block 935, the method 900 proceeds to block 955.

Returning to block 920, the method 900 proceeds to block 940 in response to the processor(s) 110 determining that there is a normal distribution of benchmark companies for the metric-of-interest. At block 940, the processor(s) 110 assign each benchmark company to a bucket based on their respective metric value for the metric-of-interest. At block 945, the processor(s) 110 assign the reference company 275 to a bucket based on its metric value for the metric-of-interest. At block 950, the processor(s) 110 determine the percentile rank of the reference company 275 based on the bucket distribution of the reference company 275 and its benchmark companies. For example, the processor(s) 110 calculate the percentile rank for the reference company 275 based on (1) the distribution among the buckets and (2) which bucket the reference company 275 is assigned.

At block 955, the processor(s) 110 assign the percentile rank of the reference company 275 as its company index score for the selected period-of-time. At block 960, the processor(s) 110 determine whether there is another period-in-time within the period-of-interest for which to generate the company index score for the reference company 275. In response to the processor(s) 110 determining that there is another period-of-time, the method 900 returns to block 905. Otherwise, in response to determining that there is not another period-of-time, the method 900 for generating company index scores ends.

In FIG. 9, the blocks are depicted as being performed by the processor(s) 110 in a sequential manner. However, the blocks may be performed by the processor(s) 110 nearly simultaneously such that the company index scores are generated all at once.

Returning to FIG. 3, the method 300 for assessing and/or predicting company performance proceeds to block 1000 upon completing block 900. At block 1000, the processor(s) 110 generate individual and collective index scores.

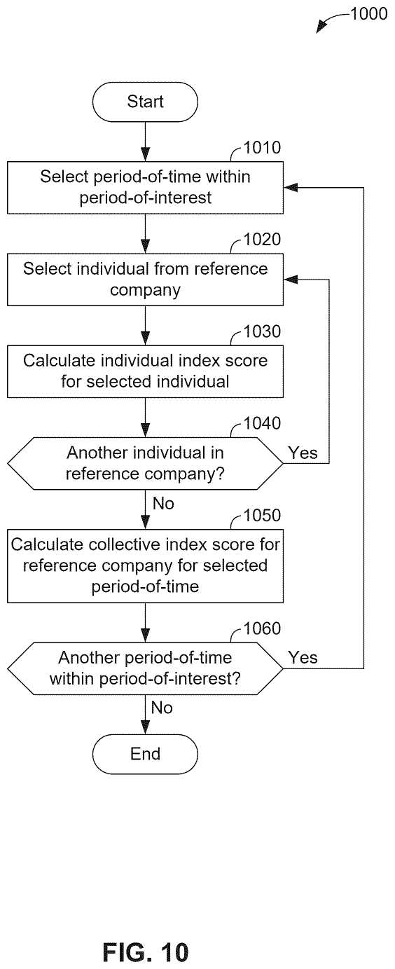

FIG. 10 is a flowchart of an example method 900 for the benchmarking system 100 to execute block 1000 of FIG. 3 to determine individual index scores for individuals and a collective index score for a reference company. The flowchart of FIG. 10 is representative of machine readable instructions that are stored in memory (such as the memory 120 of FIG. 2) and include one or more programs which, when executed by one or more processors (such as the processor(s) 110 of FIG. 2), cause the benchmarking system 100 to determine individual and collective index scores. While the example program is described with reference to the flowchart illustrated in FIG. 10, many other methods may alternatively be used. For example, the order of execution of the blocks may be rearranged, changed, eliminated, and/or combined to perform the method 1000. Further, because the method 1000 is disclosed in connection with the components of FIGS. 1-2, some functions of those components will not be described in detail below.

Initially, at block 1010, the processor(s) 110 select a period-of-time within the period-of-interest. For example, the period-of-interest was identified at block 820 of FIG. 8. At block 1020, the processor(s) select an individual that self-identified within their employment history on the social media platform 200 that they worked for the reference company 275 during the selected period-of-time.

At block 1030, the processor(s) 110 calculate an individual index score for the individual selected at block 1020 for the metric-of-interest selected at block 330 of FIG. 3. To calculate the individual index score, the processor(s) 110 identify (1) the company index score for the reference company 275 at the selected period-of-time and (2) for each preceding period-of-time in the employment history of the individual, the company index score of the corresponding company at which the individual worked for that period-of-time. The processor(s) 110 then use those company index scores to determine the individual index score for the selected individual for the selected period-of-time. For example, the processor(s) 110 calculate a running geometric mean of the company index scores identified for the individual and assign the running geometric mean as the individual index score. In some examples, the processor(s) 110 calculate the running geometric mean with a time decay.

At block 1040, the processor(s) 110 determine whether there is another individual that self-identified as working for the reference company 275 during the selected period-of-time. In response to the processor(s) 110 determining that there is another individual to select, the method 1000 returns to block 1020. Otherwise, in response to the processor(s) 110 determining that there is not another individual to select, the method 1000 proceeds to block 1050.

At block 1050, the processor(s) 110 calculate a collective index score for the reference company 275 at the selected period-of-time. To calculate the collective index score, the processor(s) 110 calculate a mean of the individual index scores calculated at block 1030 for all of the individuals who self-identified as working for the reference company 275 during the selected period-of-time. For example, to calculate the collective index score, the processor(s) 110 (1) identify individuals that worked for the company during the selected period-of-time, (2) identify the respective individual index score for each of those individuals, (3) determine the mean of those individual index scores, and (4) assign the mean as the collective index score.

At block 1060, the processor(s) 110 determine whether there is another period-of-time within the period-of-interest for which to calculate individual index scores and a collective index score. In response to the processor(s) 110 determining that there is another period-of-time, the method 1000 returns to block 1010. Otherwise, in response to the processor(s) 110 determining that there is no other period-of-time, the method 1000 for generating individual and collective index scores ends.

In FIG. 10, the blocks are depicted as being performed by the processor(s) 110 in a sequential manner. However, the blocks may be performed by the processor(s) 110 nearly simultaneously such that the individual and collective index scores are generated all at once. Returning to FIG. 3, the method 300 for assessing and/or predicting company performance proceeds to block 340 upon completing block 1000.

At block 340, the processor(s) 110 determine whether there is another metric-of-interest with which to benchmark the reference company 275. In response to the processor(s) 110 determining that there is another metric-of-interest, the method 300 returns to block 330. Otherwise, in response to the processor(s) 110 determining that there is not another metric-of-interest, the method 300 proceeds to block 350 at which the processor(s) generate report(s) and transmit the report(s) to the reference company 275 and/or other interested parties. For example, the processor(s) 110 generate the report in the form of a webpage, a portal page, a pdf, a spreadsheet, etc. The processor(s) 110 transmit the report to the reference company 275 and/or another party via an email, a text message, a link, a notification, etc.

Upon completing block 350, the method 300 for assessing and/or predicting the performance of companies based on social media content ends and returns to block 310 for another round of analysis. In FIG. 3, the blocks are depicted as being performed by the processor(s) 110 in a sequential manner. However, at least a portion of the blocks (e.g., blocks 330, 800, 900, 1000, 340) may be performed by the processor(s) 110 nearly simultaneously such that the benchmark and index score data is generated and stored all at once.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for assessing and predicting corporate performance based on social media content, the system comprising:
one or more databases configured to store social media data of user profiles of users on a social media platform, wherein the users include individuals and companies; and
one or more processors configured to:
for each of the individuals, chronologically sort a respective employment history;
generate, for periods-of-time, metric values for metrics of the users based on the social media data;
identify a reference company;
identify a metric-of-interest and a period-of-interest for assessment of the reference company, wherein the period-of-interest includes one or more of the periods-of-time;
for each of the periods-of-time within the period-of-interest:
for each of the companies, generate a respective company index score based on a percentile rank of the respective metric value for the metric-of-interest relative to a respective set of benchmark companies;
identify which of the individuals are associated with the reference company based on the respective employment histories;
for each of the individuals associated with the reference company, calculate a respective individual index score based on the respective company index scores of the reference company and preceding company index scores of preceding companies-of-employment; and
for the reference company, calculate a collective index score based on the individual index scores of the individuals associated with the reference company; and
generate and transmit a report indicative of corporate performance of the reference company.

2. The system of claim 1, wherein each of the periods-of-time is a predefined measurement-of-time by which the metrics of the users are assessed, wherein each of the periods-of-time has a same time duration, and wherein the period-of-interest is a time period during which the reference company is compared to the respective set of benchmark companies.

3. The system of claim 1, wherein, to chronologically sort the employment history for each of the individuals, the one or more processors are configured to:
identify a start date and an end date for each employment position in the social media data for the user; and
convert the start date and the end date into a longitudinal date profile.

4. The system of claim 1, wherein the metrics for the individuals include at least one of a career-tenure metric, a company-tenure metric, a role-tenure metric, an experience-tenure metric, or an industry-tenure metric.

5. The system of claim 1, wherein the metrics for the companies include at least one of a headcount metric, a time-interval metric, a diversity metric, a gender-equity metric, or a company-tenure metric.

6. The system of claim 1, wherein the one or more processors are configured to identify the respective set of benchmark companies for the reference company.

7. The system of claim 6, wherein, to identify the respective set of benchmark companies for the reference company, the one or more processors are configured to:
identify an industry classification of the reference company in the social media data; and
for each of the periods-of-time within the period-of-interest:
identify a headcount for the reference company in the social media data;
select peer companies for the reference company based on the headcount and the industry classification; and
select the respective set of benchmark companies from the peer companies.

8. The system of claim 1, wherein, to generate the company index score for the reference company, the one or more processors are configured to:
determine a mean and a standard deviation of the metric values of the metric-of-interest for the respective set of benchmark companies;
calculate a z-score of the reference company for the metric-of-interest based on the metric value of the reference company for the metric-of-interest, the mean of the respective set of benchmark companies, and the standard deviation of the respective set of benchmark companies; and
convert the z-score to the percentile rank for the reference company.

9. The system of claim 8, wherein, to calculate the z-score for the reference company, the one or more processors are configured to divide a difference between the metric value of the reference company and the mean of the respective set of benchmark companies by the standard deviation of the respective set of benchmark companies.

10. The system of claim 1, wherein, to generate the company index score for the reference company, the one or more processors are configured to:
assign the reference company and each of the respective set of benchmark companies to one of a plurality of buckets based on the metric value for the metric-of-interest; and
determine the percentile rank of the reference company based on a bucket distribution of the reference company and the respective set of benchmark companies.

11. The system of claim 1, wherein, to calculate the individual index score for each of the individuals associated with the reference company, the one or more processors are configured to calculate a running geometric mean of the company index score of the reference company and the preceding company index scores of the preceding companies-of-employment.

12. The system of claim 11, wherein the one or more processors are configured to calculate the running geometric mean with a time decay.

13. The system of claim 1, wherein, to calculate the collective index score for the reference company, the one or more processors are configured to calculate a mean of the individual index scores for the individuals associated with the reference company.

14. The system of claim 1, wherein, for each of the individuals associated with the reference company, the one or more processors are configured to identify the preceding companies-of-employment in the employment history that was chronologically sorted.

15. A method for assessing and predicting corporate performance based on social media content, the method comprising:
storing, in one or more databases, social media data of user profiles of users on a social media platform, wherein the users include individuals and companies;
chronologically sorting, via one or more processors, a respective employment history for each of the individuals;
generating, for periods-of-time via the one or more processors, metric values for metrics of the users based on the social media data;
identifying a reference company;
identifying a metric-of-interest and a period-of-interest for assessment of the reference company, wherein the period-of-interest includes one or more of the periods-of-time;
for each of the periods-of-time within the period-of-interest:
generating, via the one or more processors, a respective company index score for each of the companies based on a percentile rank of the respective metric value for the metric-of-interest relative to a respective set of benchmark companies;
identifying, via the one or more processors, which of the individuals are associated with the reference company based on the respective employment histories;
calculating, via the one or more processors, a respective individual index score for each of the individuals associated with the reference company based on the respective company index scores of the reference company and preceding company index scores of preceding companies-of-employment; and
calculating, via the one or more processors, a collective index score for the reference company based on the individual index scores of the individuals associated with the reference company; and
generating and transmitting, via the one or more processors, a report indicative of corporate performance of the reference company.

16. A computer readable medium comprising instructions, which, when executed, cause a machine to:
store, in one or more databases, social media data of user profiles of users on a social media platform, wherein the users include individuals and companies;
chronologically sort a respective employment history for each of the individuals;
generate, for periods-of-time, metric values for metrics of the users based on the social media data;
identify a reference company;
identify a metric-of-interest and a period-of-interest for assessment of the reference company, wherein the period-of-interest includes one or more of the periods-of-time;
for each of the periods-of-time within the period-of-interest:
generate a respective company index score for each of the companies based on a percentile rank of the respective metric value for the metric-of-interest relative to a respective set of benchmark companies;
identify which of the individuals are associated with the reference company based on the respective employment histories;
calculate a respective individual index score for each of the individuals associated with the reference company based on the respective company index scores of the reference company and preceding company index scores of preceding companies-of-employment; and
calculate a collective index score for the reference company based on the individual index scores of the individuals associated with the reference company; and
generate and transmit a report indicative of corporate performance of the reference company.

17. The computer readable medium of claim 16, wherein, to generate the company index score for the reference company, the instructions, when executed, further cause the machine to:
determine a mean and a standard deviation of the metric values of the metric-of-interest for the respective set of benchmark companies;
calculate a z-score of the reference company for the metric-of-interest based on the metric value of the reference company for the metric-of-interest, the mean of the respective set of benchmark companies, and the standard deviation of the respective set of benchmark companies; and
convert the z-score to the percentile rank for the reference company.

18. The computer readable medium of claim 16, wherein, to generate the company index score for the reference company, the instructions, when executed, further cause the machine to:
assign the reference company and each of the respective set of benchmark companies to one of a plurality of buckets based on the metric value for the metric-of-interest; and
determine the percentile rank of the reference company based on a bucket distribution of the reference company and the respective set of benchmark companies.

19. The computer readable medium of claim 16, wherein, to calculate the individual index score for each of the individuals associated with the reference company, the instructions, when executed, further cause the machine to calculate a running geometric mean of the company index score of the reference company and the preceding company index scores of the preceding companies-of-employment.

20. The computer readable medium of claim 16, wherein, to calculate the collective index score for the reference company, the instructions, when executed, further cause the machine to calculate a mean of the individual index scores for the individuals associated with the reference company.
